(19) United States
(12) Patent Application Publication
(10) Pub. No.: US 2025/0239126 A1
(43) Pub. Date: Jul. 24, 2025

(54) VENDING MACHINE AND PROCESS FOR AUTOMATIC DISPENSING OF LIQUID CLEANING SOLVENTS

(71) Applicant: Daniel William Lee Sams, Raleigh, NC (US)

(72) Inventor: Daniel William Lee Sams, Raleigh, NC (US)

(21) Appl. No.: 19/032,610

(22) Filed: Jan. 21, 2025

Related U.S. Application Data
(60) Provisional application No. 63/623,399, filed on Jan. 22, 2024.

(51) Int. Cl. G07F 11/42; G07F 7/08; G07F 9/00; G07F 9/02; G07F 9/10; G07F 11/58

(52) U.S. Cl. CPC G07F 11/42; G07F 7/08; G07F 9/001; G07F 9/0235; G07F 9/026; G07F 9/10; G07F 11/58

(57) ABSTRACT

A vending machine and process for automatic dispensing of liquid cleaning solvents includes: providing a plurality of containers of a liquid cleaning solvent; manufacturing a vending machine configured for automatically dispensing said plurality of containers of the liquid cleaning solvent; inserting the plurality of containers of the liquid cleaning solvent into the manufactured vending machine; and automatically dispensing the plurality of containers of the liquid cleaning solvent via the manufactured vending machine.

### CROSS-REFERENCE TO RELATED APPLICATIONS

This application claims benefit to U.S. Provisional Patent Application No. 63/623,399 filed on Jan. 22, 2024, entitled Vending Machine and Process for Automatic Dispensing of Liquid Cleaning Solvents, which is incorporated by reference in its entirety.

### FIELD OF THE DISCLOSURE

The present disclosure relates to liquid cleaning solvents, and more specifically, to a vending machine and process for automatic dispensing of such liquid cleaning solvents.

### BACKGROUND

During the late 1960s and early 1970s, amyl nitrite emerged in the LGBTQ+ communities in the United States and Europe. At that time, they were sold in small glass capsules and became popular due to their immediate effects of relaxation and heightened sexual experiences. Poppers were considered an essential part of the club and party culture among the LGBTQ+ community, particularly because of their ability to relax smooth muscles and create a brief sense of euphoria.

However, due to their recreational use and potential for abuse, the US government included amyl nitrite and other alkyl nitrites in the list of substances deemed harmful and banned their sale for recreational purposes in 1988 through the Anti-Drug Abuse Act. Consequently, manufacturers began to produce different alkyl nitrites, such as butyl nitrite and isobutyl nitrite, which were not under the banned category initially.

The popularity of poppers fluctuated over the years due to legal regulations and changes in their formulations. They remained available as ‘room odorizers’ or ‘video head cleaners’ to circumvent legal restrictions, but their use persisted in certain subcultures, especially within the LGBTQ+ community.

Currently, poppers are still used in some communities for their recreational effects, although their legal status and availability can vary from country to country. Users are warned to always be aware of the legal implications and potential health risks associated with the use of substances like poppers.

Generally speaking, liquid cleaning solvents, as used herein, may refer to glass and metal containers or small bottles of nitrite based solvent cleaners. One problem associated with liquid cleaning solvents and poppers is their availability on demand. To date there is no known vending machine or method of vending liquid cleaning solvents, like small bottles or poppers of alkyl nitrite, like butyl nitrite, isobutyl nitrite, or the like. However, the instant disclosure recognizes the demand for such liquid cleaning solvents to be sold automatically via a vending machine and vending process or method.

Another problem associated with liquid cleaning solvents and poppers is the need to keep them refrigerated prior to use. To date there is no known vending machine or method of vending liquid cleaning solvents, like small bottles or poppers of alkyl nitrites, like butyl nitrite, isobutyl nitrite, or the like, that keeps the liquid cleaning solvent refrigerated prior to use.

The instant disclosure may be designed to address at least certain aspects of the problems or needs discussed above by providing Vending Machine and Process for Automatic Dispensing of Liquid Cleaning Solvents.

### SUMMARY

The present disclosure may solve the aforementioned limitations of the currently available vending machines and processes for vending, by providing the disclosed vending machine and process for automatic dispensing of liquid cleaning solvents. The process for automatic dispensing of liquid cleaning solvents may generally include: providing a plurality of containers of a liquid cleaning solvent; manufacturing a vending machine configured for automatically dispensing said plurality of containers of the liquid cleaning solvent; inserting the plurality of containers of the liquid cleaning solvent into the manufactured vending machine; and automatically dispensing the plurality of containers of the liquid cleaning solvent via the manufactured vending machine.

In select embodiments of the disclosed process for automatic dispensing of liquid cleaning solvents, the manufacturing the vending machine configured for automatically dispensing said plurality of containers of the liquid cleaning solvent may include adding a refrigeration unit to the manufactured vending machine. The refrigeration unit may be configured to refrigerate an inside of the manufactured vending machine. Wherein, in select embodiments, the process for automatic dispensing of the liquid cleaning solvent may further include pre-cooling the plurality of containers of the liquid cleaning solvent inserted into the manufactured vending machine prior to the automatically dispensing the plurality of containers of the liquid cleaning solvent.

In select embodiments of the disclosed process for automatic dispensing of liquid cleaning solvents, the manufacturing the vending machine configured for automatically dispensing said plurality of containers of the liquid cleaning solvent may include creating at least one dispensing tray. Each dispensing tray created may include at least one compartment. Each compartment in each dispensing tray may include a conveyor belt with a pushing block or a plurality of pushing blocks along the conveyor belt. Each compartment in each tray may be configured for holding the plurality of containers of the liquid cleaning solvent in a vertical orientation on the conveyor belt. Whereby, in select embodiments, the automatically dispensing the plurality of containers of the liquid cleaning solvent via the manufactured vending machine may include moving the plurality of containers of the liquid cleaning solvent in the vertical orientation out of the front of the compartment via the conveyor belt with the pushing block or the plurality of pushing blocks.

One feature of the disclosed process for automatic dispensing of liquid cleaning solvents may be that, in select embodiments, the creating of the at least one dispensing tray with the at least one compartment with a conveyor belt with a pushing block may include affixing longitudinal spacer members on each longitudinal side of each of the compartments in each of the dispensing trays created. Wherein, the longitudinal spacer members on each longitudinal side of the compartments may be configured to center and hold the plurality of containers of the liquid cleaning solvent in the vertical orientation on the conveyor belt as they are moved out of the front of the compartment. Wherein, in select embodiments, the moving of the plurality of containers of the liquid cleaning solvent in the vertical orientation out of the front of the compartment via the conveyor belt with the pushing block may include holding the plurality of containers of the liquid cleaning solvent in the vertical orientation while moving on the conveyor belt out of the front of the compartment.

Another feature of the disclosed process for automatic dispensing of liquid cleaning solvents may be that at least one of the compartments may include a bottle width between the longitudinal spacer members on each longitudinal side of the compartment. The bottle width between the longitudinal spacer members of such compartments may be sized to hold the containers of the liquid cleaning solvent in the vertical orientation on the conveyor belt as the plurality of containers of the liquid cleaning solvent are moved out of the front of the compartment via the conveyor belt with the pushing block or the plurality of pushing blocks.

In select embodiments of the disclosed process for automatic dispensing of liquid cleaning solvents, the plurality of containers of the liquid cleaning solvent may include a plurality of multi-packs of the containers of the liquid cleaning solvent. Each multi-pack may include two containers of the liquid cleaning solvent packaged side-by-side. Wherein, in select embodiments, at least one of the compartments may include a package width between the longitudinal spacer members on each longitudinal side of the compartment. The package width may be sized to hold the plurality of the multi-packs of the containers of the liquid cleaning solvent in the vertical orientation on the conveyor belt as the plurality of the multi-packs of the containers of the liquid cleaning solvent are moved out of the front of the compartment via the conveyor belt with the pushing block.

Another feature of the disclosed process for automatic dispensing of liquid cleaning solvents may be that in select embodiments the creating of the at least one dispensing tray with the at least one compartment with a conveyor belt with a pushing block may include mounting spring retaining members on each side of the compartment at a distal end. Whereby, in select embodiments, the automatically dispensing the plurality of containers of the liquid cleaning solvent via the manufactured vending machine may include ensuring the dispensing of a single container of the liquid cleaning solvent via the spring retaining members mounted on each side of the compartment at the distal end.

In select embodiments of the disclosed process for automatic dispensing of liquid cleaning solvents, at least one of the spring retaining members mounted on at least one of the sides of the compartment at the distal end may be a magnetic spring retaining member. The magnetic spring retaining member may be configured to magnetically mount to the side of the compartment at the distal end. Wherein, in select embodiments, the mounting the spring retaining members on each side of the compartment at a distal end may include magnetically mounting the at least one magnetic spring retaining member on at least one of the sides of the compartment at the distal end.

Another feature of the disclosed process for automatic dispensing of liquid cleaning solvents may be the inclusion of tracking an inventory of the plurality of containers of the liquid cleaning solvent inserted into the vending machine and automatically dispensed from the vending machine. In select embodiments, the tracking the inventory of the plurality of containers of the liquid cleaning solvent inserted into the vending machine and automatically dispensed from the vending machine may include: attaching an RFID tag to each of the plurality of containers of the liquid cleaning solvent, like on a cap of each container of the liquid cleaning solvent; and mounting an RFID antenna above each dispensing tray provided in the vending machine, like below a top of the vending machine and on an underside of a dispensing tray, the RFID antenna may be configured to track the plurality of containers of the liquid cleaning solvent in the dispensing tray via the RFID tags attached to each of the plurality of containers of the liquid cleaning solvent. Wherein, in select embodiments, the disclosed process for automatic dispensing of liquid cleaning solvents further including providing real-time inventory tracking of the plurality of containers of the liquid cleaning solvent inserted into the vending machine and automatically dispensed from the vending machine via the RFID antenna and the RFID tags. The provided real-time inventory tracking may be configured to provide efficient restocking and for preventing stockouts.

In select embodiments, the disclosed process for automatic dispensing of liquid cleaning solvents may further comprise displaying the plurality of containers of the liquid cleaning solvent inserted into the vending machine through a transparent front window.

In select embodiments, the disclosed process for automatic dispensing of liquid cleaning solvents may further comprise insulating the inside of the vending machine by providing an injected foam cabinet.

In select embodiments, the disclosed process for automatic dispensing of liquid cleaning solvents may further comprise maintaining a required temperature inside of the vending machine via a temperature control feature. Wherein, the desired temperature is configured to be set to maintain the liquid cleaning solvents at their required temperature.

In select embodiments, the disclosed process for automatic dispensing of liquid cleaning solvents may further comprise detecting leaks inside and from the vending machine via a leak detection and containment system configured to prevent and address spills or leaks promptly.

In select embodiments, the disclosed process for automatic dispensing of liquid cleaning solvents may further comprise displaying prices, programming messages, machine status, product labels, or combinations thereof via a display monitor.

In select embodiments, the disclosed process for automatic dispensing of liquid cleaning solvents may further comprise providing a user-friendly touchscreen interface configured to display product information, prices, any necessary warnings or combinations thereof.

In select embodiments, the disclosed process for automatic dispensing of liquid cleaning solvents may further comprise transporting each of the plurality of containers of the liquid cleaning solvent via an elevator. The elevator may be configured to transport each of the plurality of containers from a tray area to a collection box.

In select embodiments, the disclosed process for automatic dispensing of liquid cleaning solvents may further comprise restricting the vertical movement of the elevator via a blocking mechanism. The blocking mechanism may be configured to mitigate the risk of theft through a collection door of the collection box by securing the plurality of containers of the liquid cleaning solvent on the dispensing trays.

In select embodiments, the disclosed process for automatic dispensing of liquid cleaning solvents may further comprise locking the vending machine via a secure locking system. The secure locking system maybe configured to prevent unauthorized access and ensure safety of the containers of the liquid cleaning solvent.

In select embodiments, the disclosed process for automatic dispensing of liquid cleaning solvents may further comprise conducting surveillance of the vending machine and the plurality of containers of the liquid cleaning solvents automatically dispensed therefrom via a surveillance system. The surveillance system may be configured for security and monitoring purposes.

In select embodiments, the disclosed process for automatic dispensing of liquid cleaning solvents may further comprise tracking the vending machine location via an asset tracking feature. The asset tracking feature may be configured to locate the vending machine.

In select embodiments, the disclosed process for automatic dispensing of liquid cleaning solvents may further comprise accepting cashless payment options including credit card or mobile payments configured to provide convenience and ease of use of the vending machine.

In select embodiments, the disclosed process for automatic dispensing of liquid cleaning solvents may further comprise: displaying the plurality of containers of the liquid cleaning solvent inserted into the vending machine through a transparent front window; insulating the inside of the vending machine by providing an injected foam cabinet; maintaining a required temperature inside of the vending machine via a temperature control feature, herein the desired temperature is configured to be set to maintain the liquid cleaning solvents at their required temperature; detecting leaks inside and from the vending machine via a leak detection and containment system configured to prevent and address spills or leaks promptly; displaying prices, programming messages, machine status, product labels, or combinations thereof via a display monitor; providing a user-friendly touchscreen interface configured to display product information, prices, any necessary warnings or combinations thereof; transporting each of the plurality of containers of the liquid cleaning solvent via an elevator, wherein the elevator may be configured to transport each of the plurality of containers from a tray area to a collection box; restricting the vertical movement of the elevator via a blocking mechanism, wherein the blocking mechanism may be configured to mitigate the risk of theft through a collection door of the collection box by securing the plurality of containers of the liquid cleaning solvent on the dispensing trays; locking the vending machine via a secure locking system, wherein the secure locking system maybe configured to prevent unauthorized access and ensure safety of the containers of the liquid cleaning solvent; conducting surveillance of the vending machine and the plurality of containers of the liquid cleaning solvents automatically dispensed therefrom via a surveillance system, wherein the surveillance system may be configured for security and monitoring purposes; tracking the vending machine location via an asset tracking feature, wherein the asset tracking feature may be configured to locate the vending machine; and accepting cashless payment options including credit card or mobile payments configured to provide convenience and ease of use of the vending machine.

In another aspect, the instant disclosure embraces a process for automatic dispensing of liquid cleaning solvents in any of the embodiments and/or combinations of embodiments shown and/or described herein.

In another aspect, the instant disclosure embraces a vending machine for automatic dispensing of a plurality of containers of a liquid cleaning solvent. The disclosed vending machine may generally include at least one dispensing tray with at least one compartment. Each compartment may include a conveyor belt with a pushing block. Each compartment may be configured for holding the plurality of containers of the liquid cleaning solvent in a vertical orientation on the conveyor belt. The pushing block may be configured to move the plurality of containers of the liquid cleaning solvent on the conveyor belt out of a front of the compartment. Each compartment may include a longitudinal spacer member on each longitudinal side of the compartment. The longitudinal spacer members on each longitudinal side of the compartment may be configured to center and hold the plurality of containers of the liquid cleaning solvent in the vertical orientation on the conveyor belt as they are moved out of the front of the compartment. Wherein, the vending machine may be designed and configured to provide automatic dispensing of the plurality of the containers of the liquid cleaning solvent.

One feature of the disclosed vending machine may be that at least one of the compartments may include a bottle width. The bottle width may be between the longitudinal spacer members on each longitudinal side of the compartment. The bottle width may be sized to hold the containers of the liquid cleaning solvent in the vertical orientation on the conveyor belt as the plurality of containers of the liquid cleaning solvent are moved out of the front of the compartment via the conveyor belt with the pushing block.

Another feature of the disclosed vending machine may be that the plurality of containers of the liquid cleaning solvent may include a plurality of multi-packs of the containers of the liquid cleaning solvent. Each multi-pack may include at least two containers of the liquid cleaning solvent packaged side-by-side. Wherein, in select embodiments of the disclosed vending machine, at least one of the compartments may include a package width between the longitudinal spacer members on each longitudinal side of the compartment. The package width may be sized to hold the plurality of the multi-packs of the containers of the liquid cleaning solvent in the vertical orientation on the conveyor belt as the plurality of the multi-packs of the containers of the liquid cleaning solvent are moved out of the front of the compartment via the conveyor belt with the pushing block.

Another feature of the disclosed vending machine may be the inclusion of a refrigeration unit. The refrigeration unit may be associated with the vending machine. The refrigeration unit may be configured to refrigerate an inside of the vending machine. The refrigeration unit may be configured to pre-cool the plurality of containers of the liquid cleaning solvent inserted into the vending machine prior to the vending machine automatically dispensing the plurality of containers of the liquid cleaning solvent.

Another feature of the disclosed vending machine may be that at least one dispensing tray with the at least one compartment with a conveyor belt with a pushing block may include spring retaining members. The spring retaining members may be on each side of the compartment at a distal end. The spring retaining members on each side of the compartment at the distal end may be configured to ensure the dispensing of a single container of the liquid cleaning solvent. In select embodiments, at least one of the spring retaining members mounted on at least one of the sides of the compartment at the distal end may be a magnetic spring retaining member. The magnetic spring retaining member may be configured to magnetically mount to the side of the compartment at the distal end. Each of the at least one magnetic spring retaining member may include a magnet configured for magnetically mounting the magnetic spring retaining member to the side of the compartment at the distal end.

In select embodiments, the disclosed vending machine may further include a plurality of RFID (radio frequency identification) tags and at least one RFID antenna. Each RFID tag may be attached to one of the plurality of containers of the liquid cleaning solvent. Each of the at least one RFID antennas may be mounted above one of the dispensing trays in the vending machine. Each of the at least one RFID antennas may be configured to track the plurality of containers of the liquid cleaning solvent in the dispensing tray via the RFID tags attached to each of the plurality of containers of the liquid cleaning solvent. Wherein, in select embodiments, the vending machine may be configured to track an inventory of the plurality of containers of the liquid cleaning solvent inserted into the vending machine and automatically dispensed from the vending machine. Wherein, in select possibly preferred embodiments, the vending machine may be configured to provide real-time inventory tracking of the plurality of containers of the liquid cleaning solvent inserted into the vending machine and automatically dispensed from the vending machine via the RFID antenna and the RFID tags. The provided real-time inventory tracking may be configured to providing efficient restocking and preventing stockouts.

In select embodiments, the disclosed vending machine may further include a transparent front window. The transparent front window may be configured for displaying the plurality of containers of the liquid cleaning solvent inserted into the vending machine.

In select embodiments, the disclosed vending machine may further include an injected foam cabinet configured to insulate the inside of the vending machine.

In select embodiments, the disclosed vending machine may further include a temperature control feature configured to maintain a required temperature inside of the vending machine. Wherein the desired temperature may be configured to be set to maintain the liquid cleaning solvents at their required temperature.

In select embodiments, the disclosed vending machine may further include a leak detection and containment system configured to detect leaks inside and from the vending machine. The leak detection and containment system may be configured to prevent and address spills or leaks promptly.

In select embodiments, the disclosed vending machine may further include a display monitor configured to display prices, programming messages, machine status, product labels, the like, and/or combinations thereof.

In select embodiments, the disclosed vending machine may further include a user- friendly touchscreen interface configured to display product information, prices, any necessary warnings, the like, and/or combinations thereof.

In select embodiments, the disclosed vending machine may further include an elevator configured to transport dispensed containers of the liquid cleaning solvent. The elevator may be configured to transport each dispensed container from a tray area to a collection box.

In select embodiments, the disclosed vending machine may further include a blocking mechanism configured to restrict the vertical movement of the elevator. The blocking mechanism may be configured to mitigate the risk of theft through a collection door of the collection box by securing the plurality of containers of the liquid cleaning solvent on the dispensing trays.

In select embodiments, the disclosed vending machine may further include a secure locking system configured to lock the vending machine. The secure locking system may be configured to prevent unauthorized access and ensure safety of the stored containers of the liquid cleaning solvent.

In select embodiments, the disclosed vending machine may further include a surveillance system configured to conduct surveillance of the vending machine and the plurality of containers of the liquid cleaning solvents automatically dispensed therefrom. The surveillance system may be configured for security and monitoring purposes.

In select embodiments, the disclosed vending machine may further include an asset tracking feature configured to track the vending machine location. The asset tracking feature may be configured to locate the vending machine.

In select embodiments, the disclosed vending machine may further include a cashless payment feature configured to accept cashless payment options including credit card, mobile payments and/or the like. The cashless payment feature may be configured to provide convenience and ease of use of the vending machine.

In select embodiments, the disclosed vending machine may further include: a transparent front window configured for displaying the plurality of containers of the liquid cleaning solvent inserted into the vending machine; an injected foam cabinet configured to insulate the inside of the vending machine; a temperature control feature configured to maintain a required temperature inside of the vending machine, wherein the desired temperature may be configured to be set to maintain the liquid cleaning solvents at their required temperature; a leak detection and containment system configured to detect leaks inside and from the vending machine, wherein the leak detection and containment system may be configured to prevent and address spills or leaks promptly; a display monitor configured to display prices, programming messages, machine status, product labels, the like, and/or combinations thereof; a user-friendly touchscreen interface configured to display product information, prices, any necessary warnings, the like, and/or combinations thereof; an elevator configured to transport dispensed containers of the liquid cleaning solvent, wherein the elevator may be configured to transport each dispensed container from a tray area to a collection box; a blocking mechanism configured to restrict the vertical movement of the elevator, wherein the blocking mechanism may be configured to mitigate the risk of theft through a collection door of the collection box by securing the plurality of containers of the liquid cleaning solvent on the dispensing trays; a secure locking system configured to lock the vending machine, wherein the secure locking system may be configured to prevent unauthorized access and ensure safety of the stored containers of the liquid cleaning solvent; a surveillance system configured to conduct surveillance of the vending machine and the plurality of containers of the liquid cleaning solvents automatically dispensed therefrom, wherein the surveillance system may be configured for security and monitoring purposes; an asset tracking feature configured to track the vending machine location, wherein the asset tracking feature may be configured to locate the vending machine; and a cashless payment feature configured to accept cashless payment options including credit card, mobile payments and/or the like, wherein the cashless payment feature may be configured to provide convenience and ease of use of the vending machine.

In another aspect, the instant disclosure embraces the disclosed vending machine for automatic dispensing of a plurality of containers of a liquid cleaning solvent in any of the various embodiments and/or combination of embodiments shown and/or described herein.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is a schematic diagram of a flow chart of the disclosed process for automatically vending liquid cleaning solvents according to select embodiments of the instant disclosure;

FIG. 2 is a schematic diagram of a flow chart of the disclosed process for automatically vending liquid cleaning solvents according to select embodiments of the instant disclosure;

FIG. 3 is a schematic diagram of a flow chart of the disclosed process for automatically vending liquid cleaning solvents according to select embodiments of the instant disclosure;

FIG. 4 is a front view of the disclosed vending machine according to select embodiments of the instant disclosure;

FIG. 5 is a front, top perspective view of a dispensing tray for the disclosed vending machine according to select embodiments of the instant disclosure;

FIG. 6 is a top perspective view of another dispensing tray for the disclosed vending machine according to select embodiments of the instant disclosure with single wide compartments with the bottle width between the longitudinal spacers in some compartments and double wide compartments with the package width between the longitudinal spacers in other compartments for multi-packs, for the double wide compartments, the compartments are extended height for providing double high multi-packs ideal for the top dispensing tray in the vending machine with the additional space before the top of the vending machine;

FIG. 7 is a front, top perspective view of the dispensing tray from FIG. 6;

FIG. 8 is a left side perspective view of the dispensing tray from FIG. 6;

FIG. 9 is a top perspective view of another dispensing tray for the disclosed vending machine according to select embodiments of the instant disclosure with just single wide compartments with the bottle width between the longitudinal spacers for a smaller vending machine with only 7 compartments across each dispensing tray;

FIG. 10 is a front, top perspective view of the dispensing tray from FIG. 9;

FIG. 11 is a left side perspective view of the dispensing tray from FIG. 9;

FIG. 12 is a top perspective view of another dispensing tray for the disclosed vending machine according to select embodiments of the instant disclosure with just single wide compartments with the bottle width between the longitudinal spacers for a larger vending machine with 10 compartments across each dispensing tray;

FIG. 13 is a front, top perspective view of the dispensing tray from FIG. 12;

FIG. 14 is a ride side perspective view of the dispensing tray from FIG. 12;

FIG. 15 is a zoomed in view of a compartment of a dispensing tray for the disclosed vending machine according to select embodiments of the instant disclosure showing a single container being dispensed between two spring retaining members at the front of the compartment;

FIG. 16 is a zoomed in view of another compartment of a dispensing tray for the disclosed vending machine according to select embodiments of the instant disclosure showing a single container being dispensed between two spring retaining members at the front of the compartment;

FIG. 17 is a zoomed in view of another compartment of a dispensing tray for the disclosed vending machine showing the bottle width between the longitudinal spacers affixed on each longitudinal side of the compartment;

FIG. 18 is a zoomed in view of another compartment of a dispensing tray for the disclosed vending machine showing an embodiment of a magnetic spring retaining member being slid into position on the outer side of an outer compartment of the dispensing tray;

FIG. 19 is a top view of a magnetic spring retaining member according to select embodiments of the instant disclosure; and

FIG. 20 is a side view of the magnetic spring retaining member of FIG. 19.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

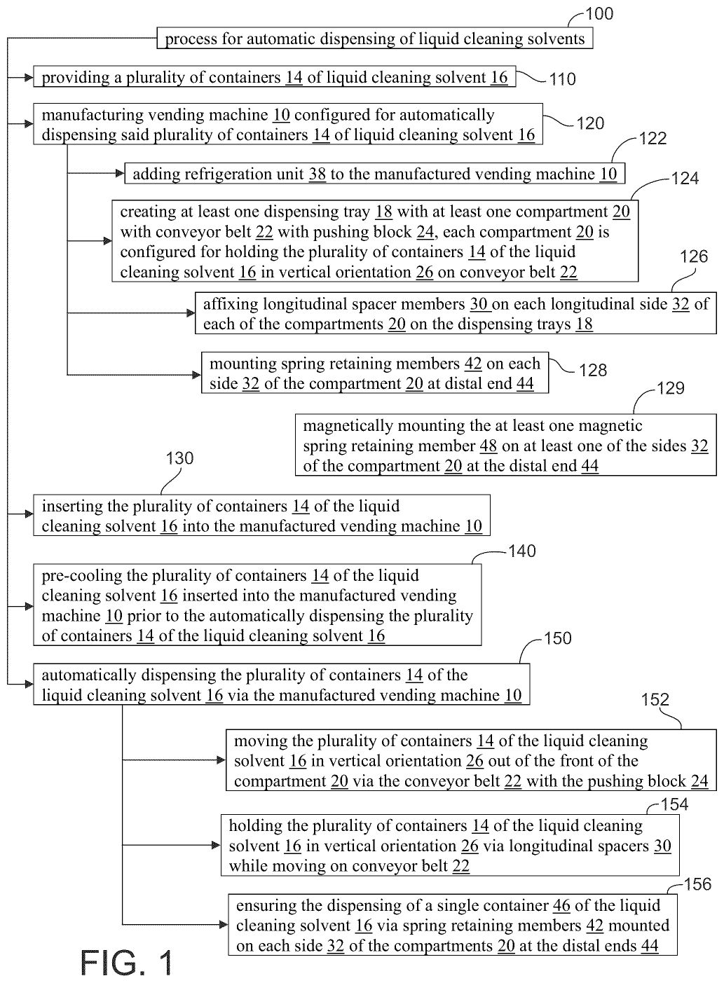

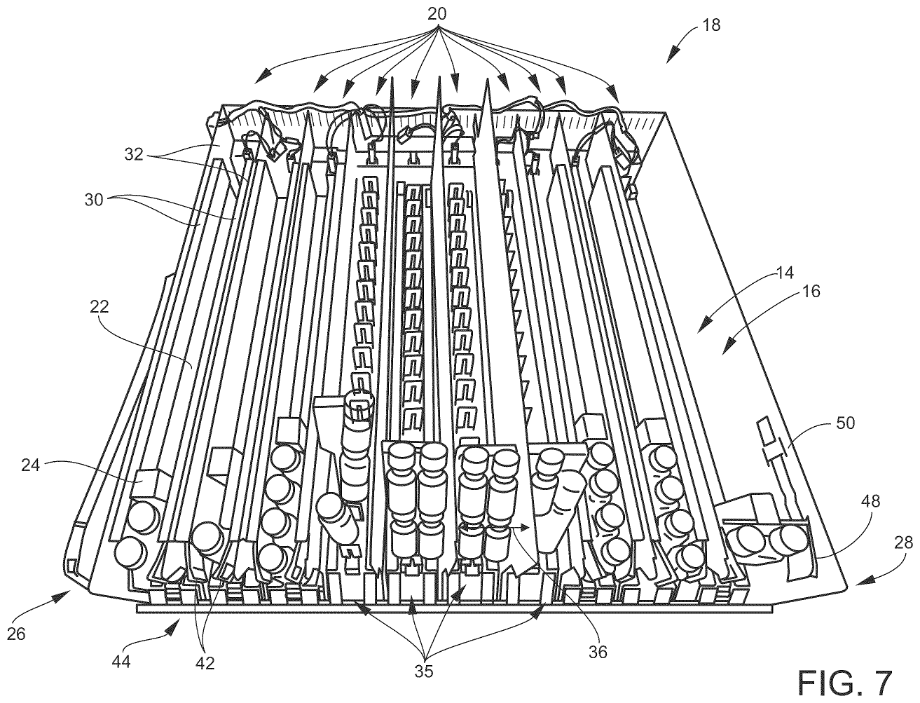

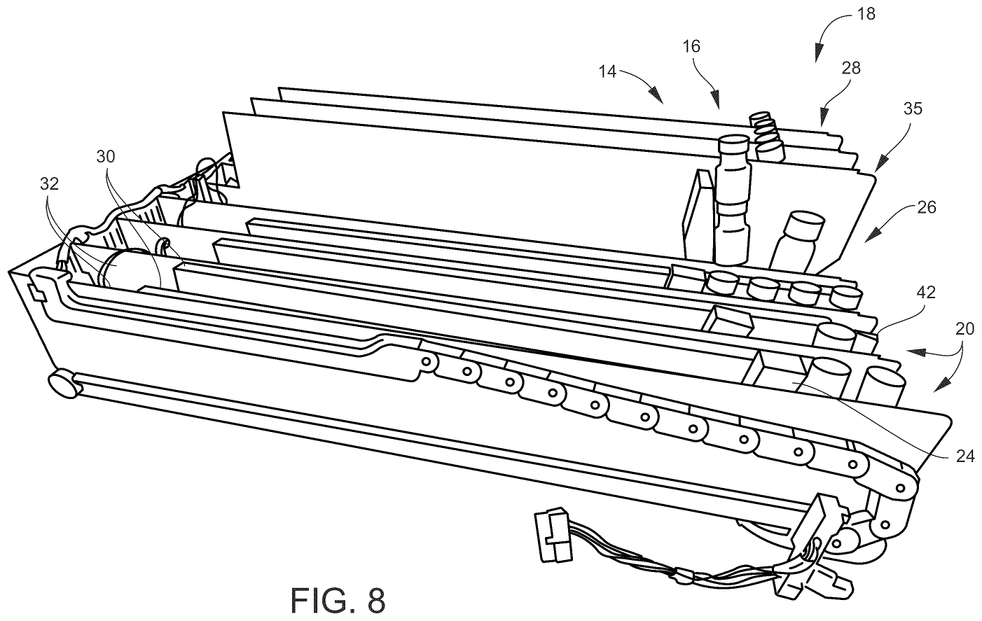

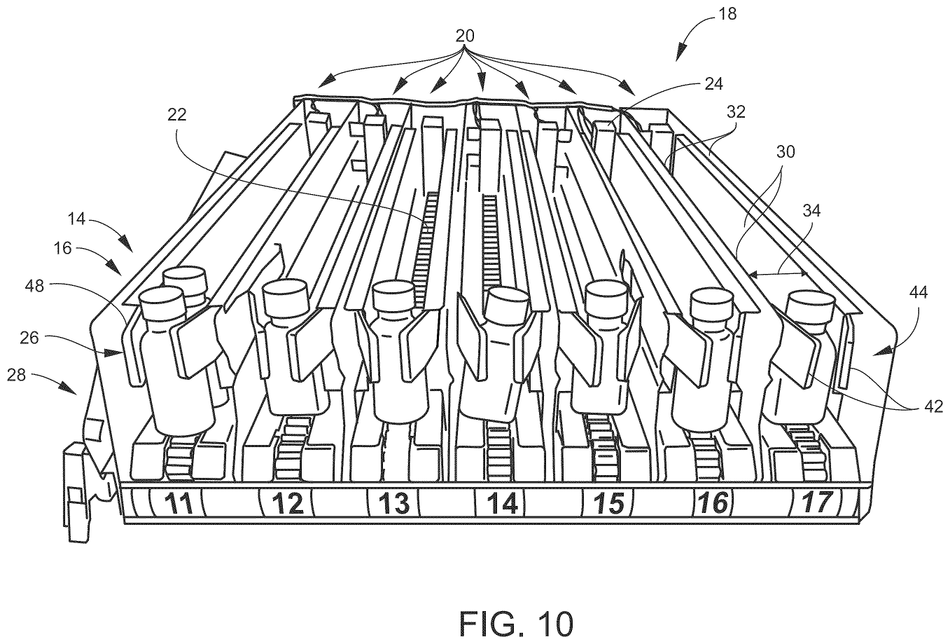

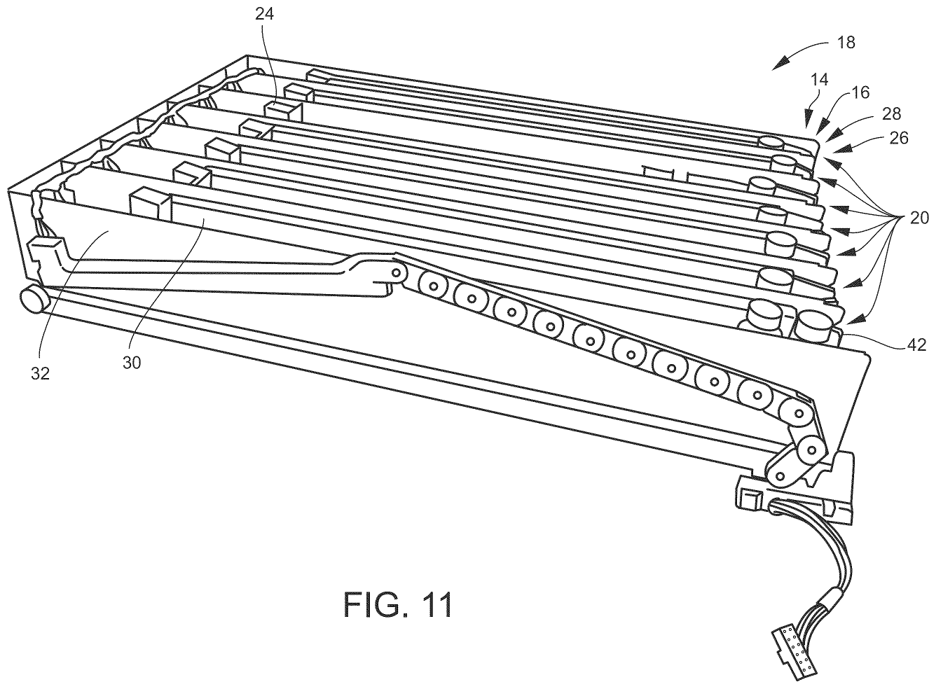

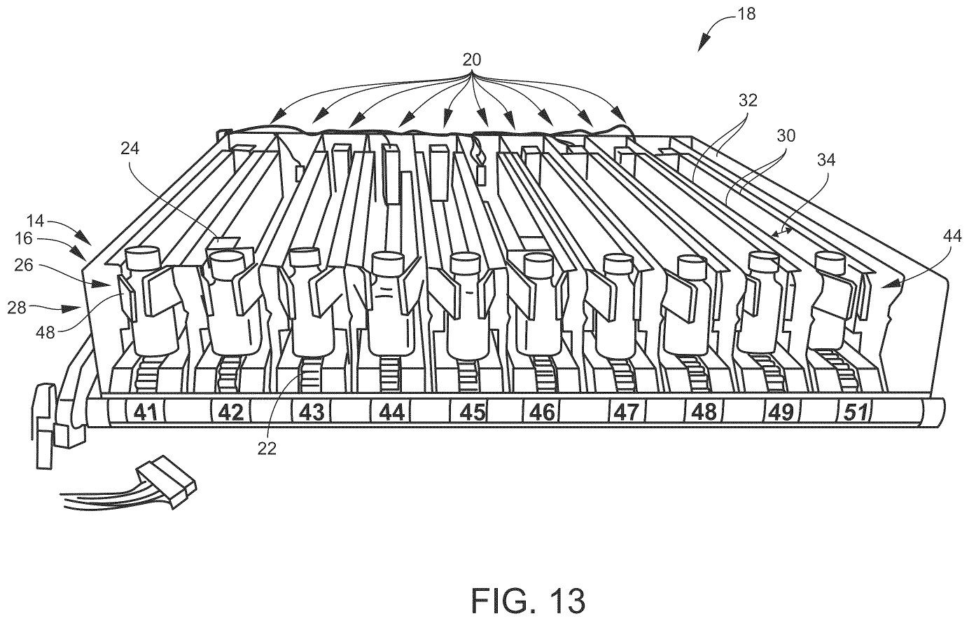

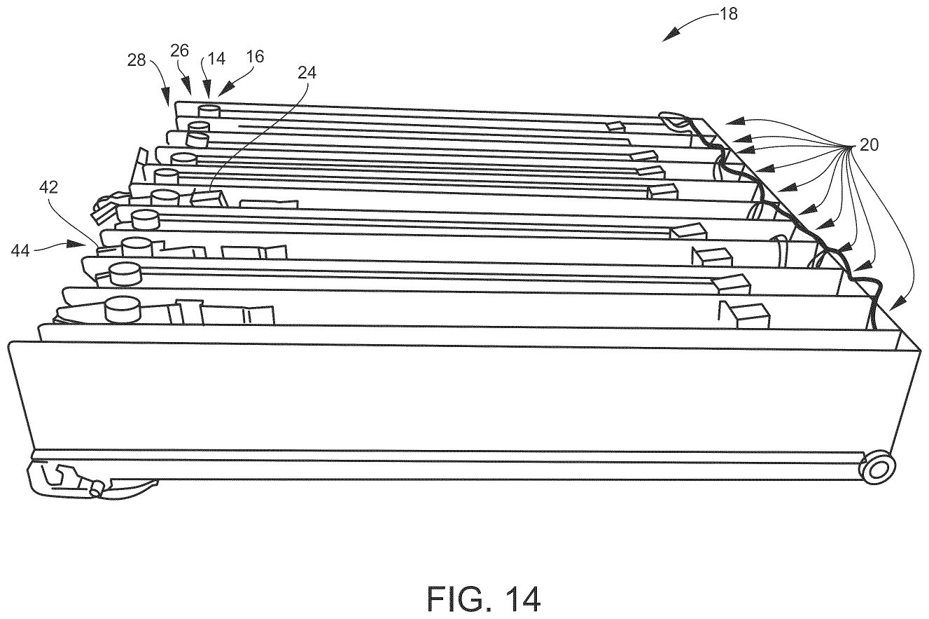

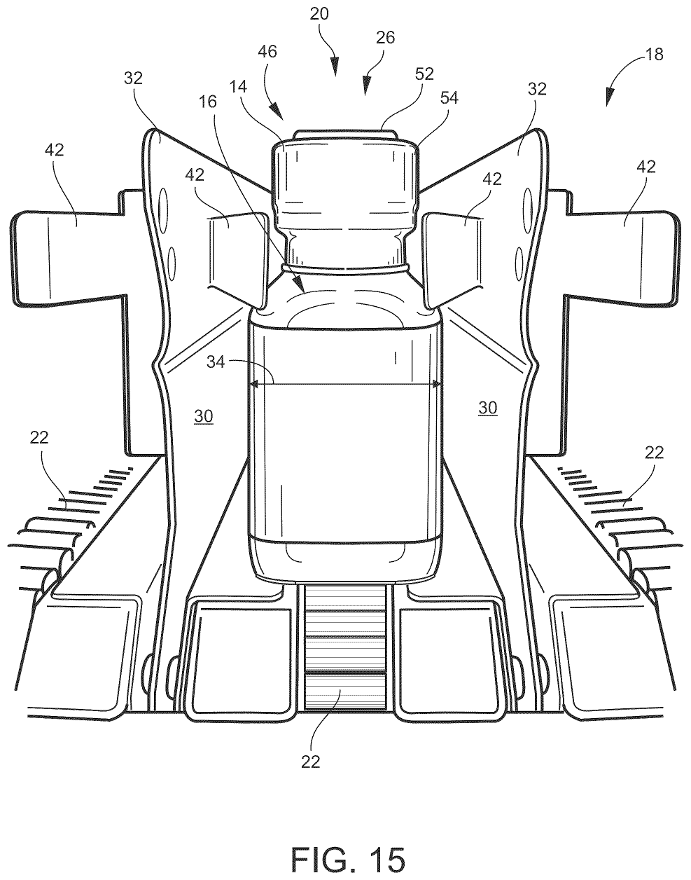

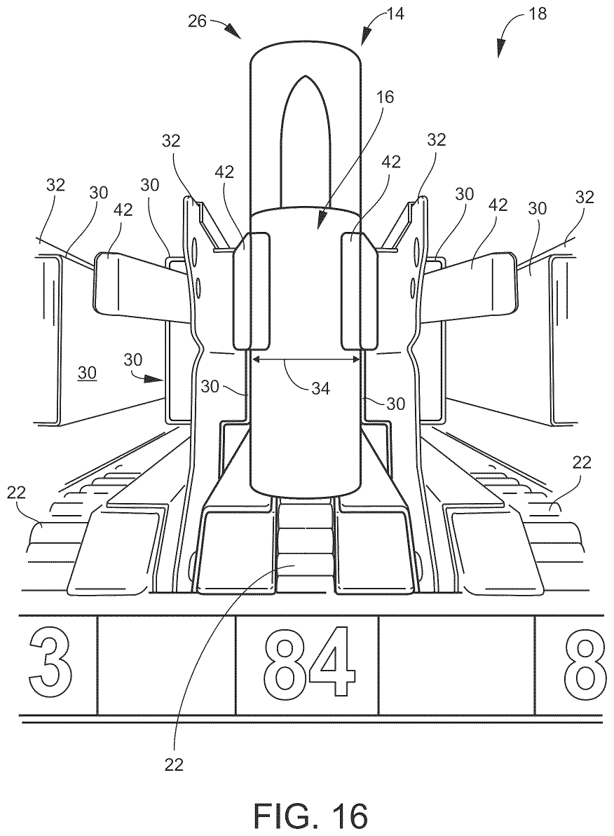

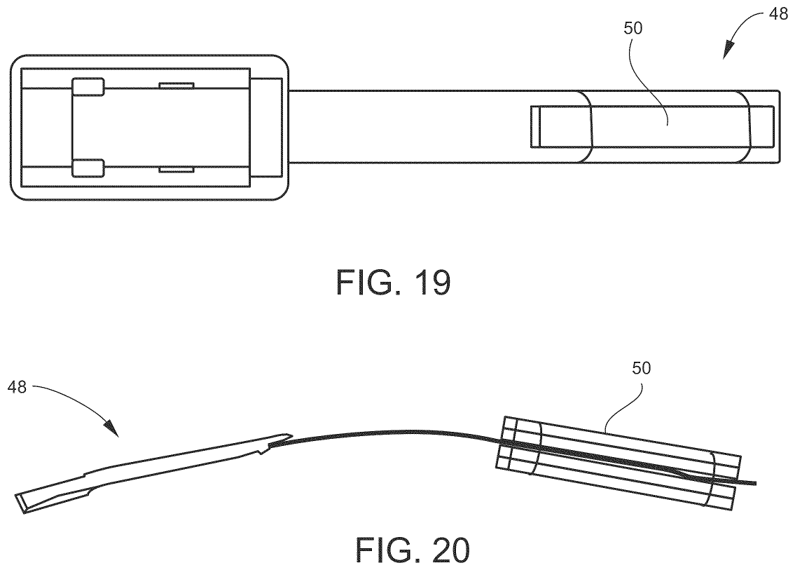

Referring now to FIGS. 1-20, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

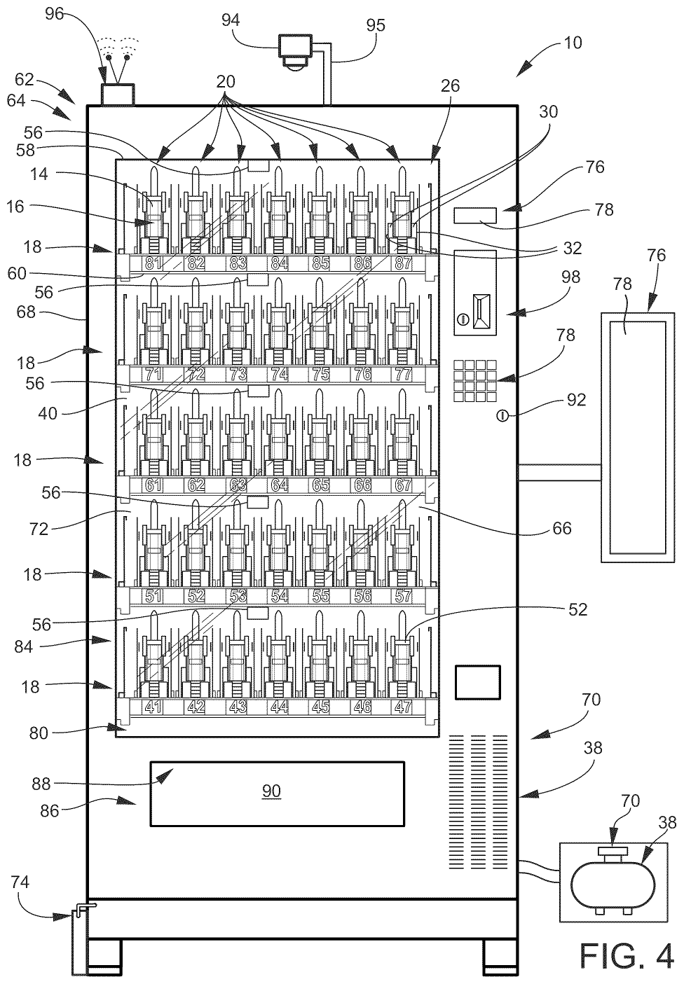

Referring to FIGS. 1-3, with reference to FIGS. 4-20, the present disclosure may solve the aforementioned limitations of the currently available vending machines and process for selling liquid cleaning solvents by providing vending machine 10 and process 100 for automatic dispensing of liquid cleaning solvents 16. Vending machine 10 and process 100 for automatic dispensing of liquid cleaning solvents 16 may provide a means and/or process for automatic selling, vending, dispensing or the like of liquid cleanings solvents 16. Liquid cleaning solvents 16, as used herein, may refer to liquid cleaning solvents contained in various colored (like amber) glass (or metal) bottles of various sizes and shapes, like sized 10 ml or 15 ml, 30 ml. The bottles may contain the liquid cleaning solvents, which is typically yellowish in color and has a distinctive, fruity, sweetish aroma (although this varies depending on the particular nitrite used.) Examples of the types of nitrites that may be used in the disclosed liquid cleaning solvents 16 may be shown in U.S. Pat. No. 5,646,181 for a method for treating impotence, which is incorporated herein in its entirety. In addition, the following may be, but is not limited to a list of example liquid cleaning solvents 16 that could be used in select embodiments of the disclosed vending machine 10 and process 100 for automatic dispensing of liquid cleaning solvents 16: Amyl nitrite (isoamyl nitrite, isopentyl nitrite, with a CAS of 110-46-3, a formula of (CH3)2CH(CH2)2ONO, a molecular weight of 117.15 g/mol, a physical state of liquid, a color of yellow, and/or a boiling point of 97-99° C. (207-210° F.)); pentyl nitrite (n-pentyl nitrite, with a CAS of 463-04-7, a formula of CH3(CH2)4ONO, a molecular weight of 117.15 g/mol, a physical state of liquid, a color of yellow, and/or a boiling point of 104° C. (219° F.)); butyl nitrite (n-butyl nitrite with a CAS of 544-16-1, a formula of CH3(CH2)3ONO, a molecular weight of 103.12 g/mol, a physical sate of liquid, a color of yellow, and/or a boiling point of 78° C. (172° F.)); isobutyl nitrite (2-methylpropyl nitrite, with a CAS of 542-56-3, a formula of (CH3)2CHCH2ONO, a molecular weight of 103.12 g/mol, a physical state of liquid, a color of colorless or transparent, and/or a boiling point of 67° C. (153° F.)); isopropyl nitrite (2-propyl nitrite with a CAS of 541-42-4, a formula of (CH3)2CHONO, a molecular weight of 89.09 g/mol, a physical state of liquid, a color of yellow, and/or a boiling point of 39° C. (102° F.)), hexyl nitrite (with a CAS of 638-51-7, a formula of CH3(CH2)5ONO, a molecular weight of 131.17 g/mol, a physical state of liquid, a color of colorless or transparent, and/or a boiling point of 130° C. (266° F.)); isopentyl nitrite (molecular weight of 117.15 g/mol and a boiling point of 97-99 degrees Celsius or 207-210 degrees Fahrenheit), the like, and/or combinations thereof. In select embodiments, liquid cleaning solvent 16 may refer to cyclohexyl nitrite, which is the ester of cyclohexanol and nitrous acid, i.e. it is an alkyl nitrite. Like amyl nitrite and butyl nitrite, cyclohexyl nitrite acts as an antianginal due to vasodilation. The compound is colorless, volatile liquid. In select embodiments, liquid cleaning solvent 16 may refer to chloroethane, commonly known as ethyl chlorides.

Referring now specifically to FIGS. 1-3, select embodiments of process 100 for automatic dispensing of liquid cleaning solvents 16 is shown. Process 100 for automatic dispensing of liquid cleaning solvents may generally include: step 110 of providing a plurality of containers 14 of liquid cleaning solvent 16; step 120 of manufacturing vending machine 10 (like as shown in any of the various embodiments and/or combination of embodiments shown in FIGS. 4-20) configured for automatically dispensing said plurality of containers 14 of liquid cleaning solvent 16; step 130 of inserting the plurality of containers 14 of liquid cleaning solvent 16 into the manufactured vending machine 10; and step 150 of automatically dispensing the plurality of containers 14 of the liquid cleaning solvent 16 via the manufactured vending machine 10.

As shown in FIG. 1, in select embodiments of process 100 for automatic dispensing of liquid cleaning solvents 16, step 120 of manufacturing vending machine 10 configured for automatically dispensing said plurality of containers 14 of liquid cleaning solvent 16 may include step 122 of adding refrigeration unit 38 to the manufactured vending machine 10. However, the disclosure is not so limited, and vending machine 10 may be made without refrigeration unit 38 when pre-cooling of liquid cleaning solvents 16 is not required or desired. Refrigeration unit 38 may be configured to refrigerate inside 40 of the manufactured vending machine 10. Wherein, in select embodiments, process 100 for automatic dispensing of liquid cleaning solvent 16 may further include step 140 of pre-cooling the plurality of containers 14 of the liquid cleaning solvent 16 inserted into the manufactured vending machine 10 prior to step 150 of automatically dispensing the plurality of containers 14 of the liquid cleaning solvent 16.

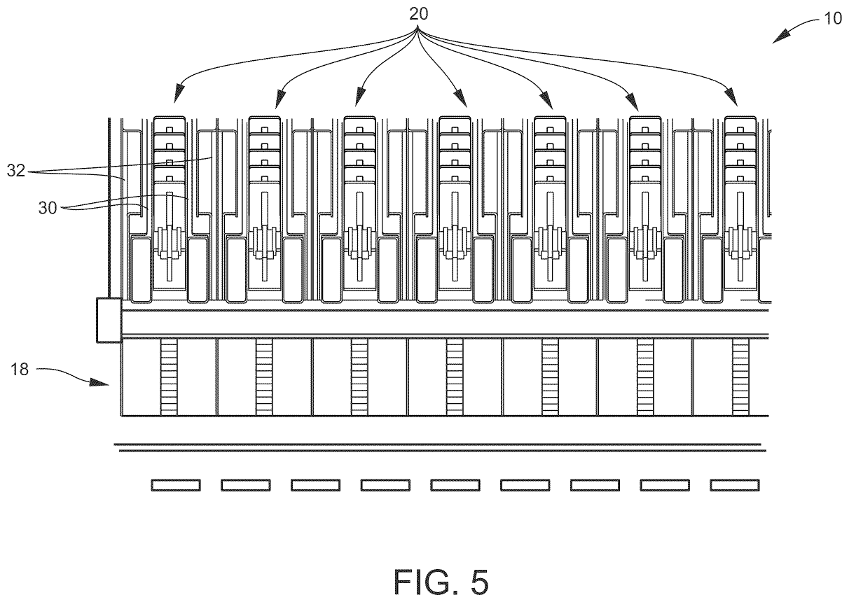

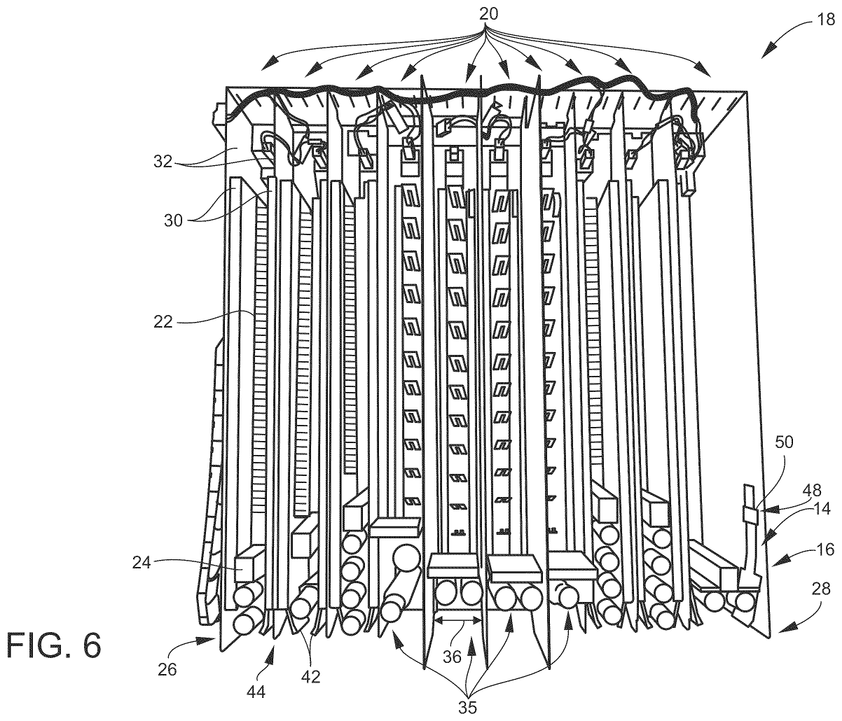

Still referring to FIG. 1, in select embodiments of process 100 for automatic dispensing of liquid cleaning solvents 16, step 120 of manufacturing the vending machine 10 configured for automatically dispensing said plurality of containers 14 of the liquid cleaning solvent 16 may include step 124 of creating at least one dispensing tray 18. Each dispensing tray 18 created may include at least one compartment 20. Each compartment 20 in each dispensing tray 18 created may include conveyor belt 22 with a single pushing block 24 (see FIGS. 6-14 and 18) or a plurality of pushing blocks 24 (see FIGS. 5-7 and 17) along conveyor belt 22. Each compartment 20 in each dispensing tray 18 may be configured for holding the plurality of containers 14 of the liquid cleaning solvent 16 in vertical orientation 26 on conveyor belt 22, as illustrated in the Figures. Whereby, in select embodiments, step 150 of automatically dispensing the plurality of containers 14 of the liquid cleaning solvent 16 via the manufactured vending machine 10 may include step 152 of moving the plurality of containers 14 of the liquid cleaning solvent 16 in vertical orientation 26 out of front 28 of each compartment 20 via conveyor belt 22 with pushing block 24 or the plurality of pushing blocks 24.

Still referring to FIG. 1, one feature of process 100 for automatic dispensing of liquid cleaning solvents may be that, in select embodiments, step 124 of creating of the at least one dispensing tray 18 with the at least one compartment 20 with conveyor belt 22 with pushing block 24 may include step 126 of affixing longitudinal spacer members 30 on each longitudinal side 32 of each of the compartments 20 in each of the dispensing trays 18 created. Wherein, the longitudinal spacer members 30 on each longitudinal side 32 of the compartments 20 may be configured to center and hold the plurality of containers 14 of the liquid cleaning solvent 16 in the vertical orientation 26 on the conveyor belt 22 as they are moved out of the front 28 of their respective compartment 20. Wherein, in select embodiments, step 152 of moving of the plurality of containers 14 of the liquid cleaning solvent 16 in the vertical orientation 26 out of front 28 of the compartment 20 via the conveyor belt 22 with the pushing block 24 may include step 154 of holding the plurality of containers 14 of the liquid cleaning solvent 16 in the vertical orientation 26 while moving on the conveyor belt 22 out of the front 28 of the compartment 20.

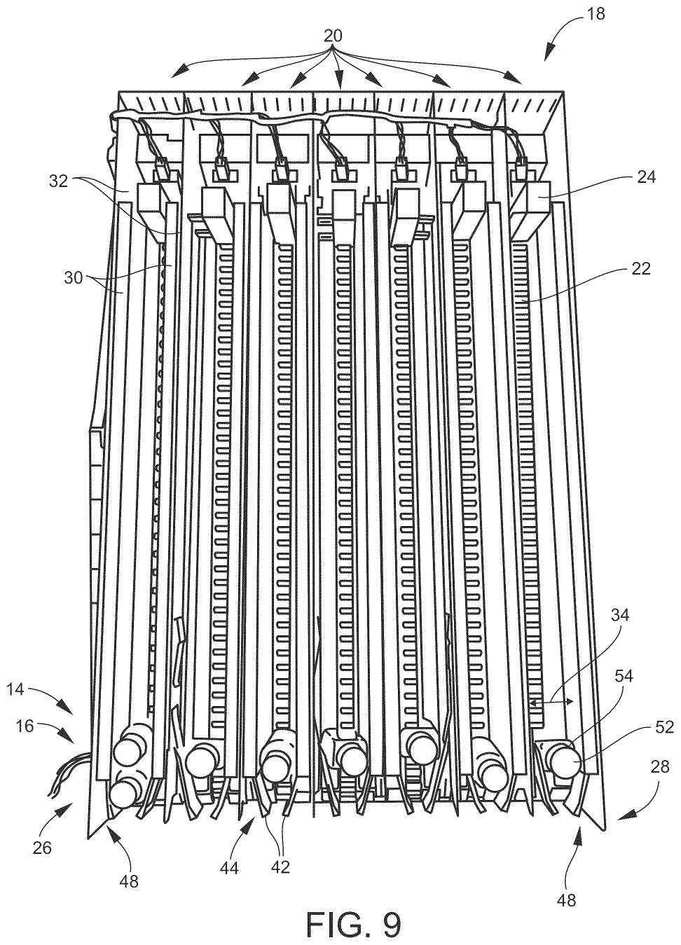

Another feature of process 100 for automatic dispensing of liquid cleaning solvents 16 may be that at least one of the compartments 20 may include bottle width 34 between the longitudinal spacer members 30 on each longitudinal side 32 of the compartment 20 (see FIGS. 9, 10, 12, 13, 15, 16, and 17). Bottle width 34 between the longitudinal spacer members 30 of such compartments 20 may be sized to hold the containers 14 of the liquid cleaning solvent 16 in the vertical orientation 26 on the conveyor belt 22 as the plurality of containers 14 of the liquid cleaning solvent 16 are moved out of the front 28 of the compartment 20 via the conveyor belt 22 with the pushing block 24 or the plurality of pushing blocks 24.

In select embodiments of process 100 for automatic dispensing of liquid cleaning solvents 16, the plurality of containers 14 of the liquid cleaning solvent 16 may include a plurality of multi-packs 35 of the containers 14 of the liquid cleaning solvent 16. See FIGS. 6-8. The multi-packs 35 of containers 14 of liquid cleaning solvent 16 may include any number of plurality of containers 14 of liquid cleaning solvent 16, including containers 14 packaged side-by side and/or on top of each other. Multi-packs 35 of containers 14 stacked on top of each other may be especially useful in the top dispensing tray where there is typically additional room for taller products. In select embodiments, each multi-pack 35 may include two containers 14 of the liquid cleaning solvent 16 packaged side-by-side. Wherein, in these select embodiments, at least one of the compartments 20 may include package width 36 between the longitudinal spacer members 30 on each longitudinal side 32 of the compartment 20. Package width 36 may be sized to hold the plurality of multi-packs 35 of the containers 14 of the liquid cleaning solvent 16 in the vertical orientation 26 on the conveyor belt 22 as the plurality of multi-packs 35 of the containers 14 of the liquid cleaning solvent 16 are moved out of the front 28 of the compartment 20 via the conveyor belt 22 with the pushing block 24 or plurality of pushing blocks 24.

Still referring to FIG. 1, another feature of process 100 for automatic dispensing of liquid cleaning solvents 16 may be that in select embodiments step 124 of creating of the at least one dispensing tray 18 with the at least one compartment 20 with a conveyor belt 22 with a pushing block 24 or multiple pushing blocks 24 may include step 128 of mounting spring retaining members 42 on each side 32 of the compartment 20 at distal end 44. Whereby, in select embodiments, step 150 of automatically dispensing the plurality of containers 14 of the liquid cleaning solvent 16 via the manufactured vending machine 10 may include step 158 of ensuring the dispensing of single container 46 of the liquid cleaning solvent 16 via the spring retaining members 48 mounted on each side 32 of the compartment 20 at the distal end 44.

Still referring to FIG. 1, in select embodiments of process 100 for automatic dispensing of liquid cleaning solvents 16, at least one of the spring retaining members 48 mounted on at least one of the sides 32 of the compartment 20 at the distal end 44 may be magnetic spring retaining member 48. Sec FIGS. 6, 7, 18, 19 and 20. Magnetic spring retaining member 48 may be configured to magnetically mount to the side 32 of the compartment 20 at distal end 44 via magnet 50 included with magnetic spring retaining member 48. Magnetic spring retaining member 48 may be added to certain vending machines that do not include spring retaining members on the outer sides 32 of the outer compartments 20 of each dispensing tray 18. As such, magnetic spring retaining member 48 may be retrofitted onto such vending machines 10 to provide spring retaining members 42 on each side 32 of each compartment 20 at distal end 44. Wherein, in select embodiments of process 100, step 128 of mounting spring retaining members 42 on each side 32 of the compartments 20 at distal end 44 may include step 129 of magnetically mounting the at least one magnetic spring retaining member 48 on at least one of the sides 32 of the compartment 20 at the distal end 44.

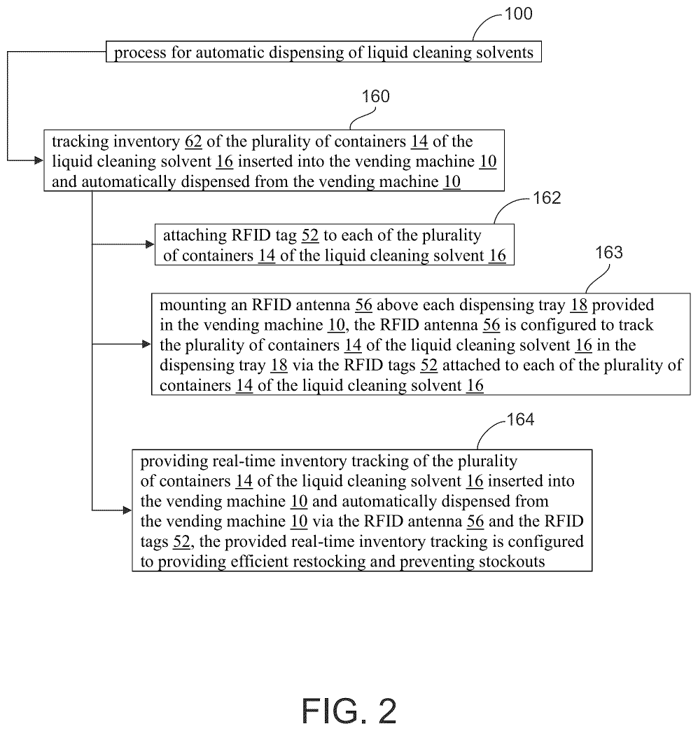

Referring now to FIG. 2, another feature of process 100 for automatic dispensing of liquid cleaning solvents 16 may be the inclusion of step 160 of tracking inventory 62 of the plurality of containers 14 of liquid cleaning solvent 16 inserted into vending machine 10 and automatically dispensed from vending machine 10. In select embodiments, step 160 of tracking the inventory of the plurality of containers 14 of the liquid cleaning solvent 16 inserted into vending machine 10 and automatically dispensed from vending machine 10 may include: step 162 of attaching an RFID tag 52 to each of the plurality of containers 14 of the liquid cleaning solvent 16, like on cap 54 of each container 14 of the liquid cleaning solvent 16; and step 163 of mounting RFID antenna 56 above each dispensing tray 18 provided in vending machine 10, like below top 58 of vending machine 10 for the uppermost dispensing tray and on underside 60 of each dispensing tray 18 for all of the other dispensing trays. The RFID antenna 56 may be configured to track the plurality of containers 14 of the liquid cleaning solvent 16 in the dispensing tray 18 via the RFID tags 52 attached to each of the plurality of containers 14 of the liquid cleaning solvent 16. Wherein, in select embodiments, process 100 for automatic dispensing of liquid cleaning solvents 16 may further include step 164 of providing real-time inventory tracking 64 of the plurality of containers 14 of the liquid cleaning solvent 16 inserted into vending machine 10 and automatically dispensed from vending machine 10 via RFID antennas 56 and the RFID tags 52. The provided real-time inventory tracking may be configured to provide efficient restocking, for preventing stockouts, the like, and/or combinations thereof. In select embodiments, RFID tags 52 may be a EOS-110R6P zero base paper sticker, a EOS-200 U8 plastic sticker, or an EOS-200 U8 wet inlay from Tageos SAS of Montpellier, France.

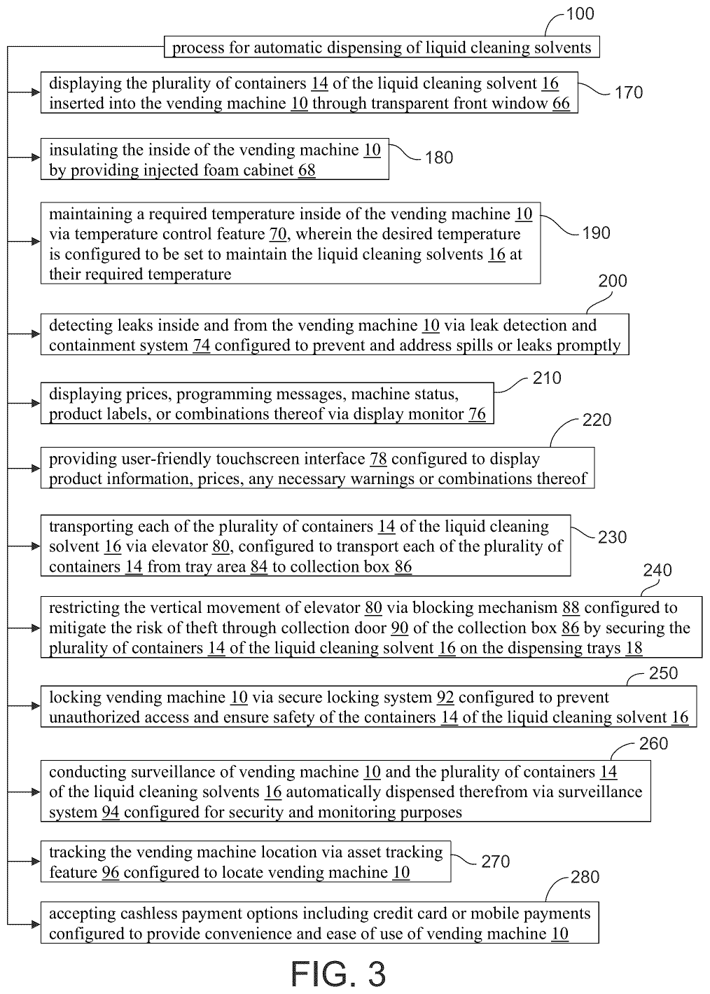

Referring now to FIG. 3, in select embodiments, process 100 for automatic dispensing of liquid cleaning solvents 16 may further comprise step 170 of displaying the plurality of containers 14 of the liquid cleaning solvent 16 inserted into vending machine 10 through transparent front window 66.

Referring now to FIG. 3, in select embodiments, process 100 for automatic dispensing of liquid cleaning solvents 16 may further comprise step 180 of insulating inside 40 of vending machine 10 by providing injected foam cabinet 68.

Referring now to FIG. 3, in select embodiments, process 100 for automatic dispensing of liquid cleaning solvents 16 may further comprise step 190 of maintaining a required temperature 72 inside of vending machine 10 via temperature control feature 70. Wherein, the desired temperature may be configured to be set to maintain the liquid cleaning solvents 16 at their required temperature 72.

Referring now to FIG. 3, in select embodiments, process 100 for automatic dispensing of liquid cleaning solvents 16 may further comprise step 200 of detecting leaks inside and from vending machine 10 via leak detection and containment system 74 configured to prevent and address spills or leaks promptly.

Referring now to FIG. 3, in select embodiments, process 100 for automatic dispensing of liquid cleaning solvents 16 may further comprise step 210 of displaying prices, programming messages, machine status, product labels, or combinations thereof via a display monitor 76.

Referring now to FIG. 3, in select embodiments, process 100 for automatic dispensing of liquid cleaning solvents 16 may further comprise step 220 of providing a user-friendly touchscreen interface 78 configured to display product information, prices, any necessary warnings or combinations thereof.

Referring now to FIG. 3, in select embodiments, process 100 for automatic dispensing of liquid cleaning solvents 16 may further comprise step 230 of transporting each of the plurality of containers 14 of the liquid cleaning solvent 16 via elevator 80. Elevator 80 may be configured to transport each of the plurality of containers 14 from tray area 84 to collection box 86.

Referring now to FIG. 3, in select embodiments, process 100 for automatic dispensing of liquid cleaning solvents 16 may further comprise step 240 of restricting the vertical movement of elevator 80 via blocking mechanism 88. Blocking mechanism 88 may be configured to mitigate the risk of theft through collection door 90 of the collection box 86 by securing the plurality of containers 14 of the liquid cleaning solvent 16 on the dispensing trays 18.

Referring now to FIG. 3, in select embodiments, process 100 for automatic dispensing of liquid cleaning solvents 16 may further comprise step 250 of locking vending machine 10 via secure locking system 92. Secure locking system 92 may be configured to prevent unauthorized access and ensure safety of the containers 14 of the liquid cleaning solvent 16.

Referring now to FIG. 3, in select embodiments, process 100 for automatic dispensing of liquid cleaning solvents 16 may further comprise step 260 of conducting surveillance of vending machine 10 and the plurality of containers 14 of the liquid cleaning solvents 16 automatically dispensed therefrom via surveillance system 94. Surveillance system 94 may be configured for security and monitoring purposes.

Referring now to FIG. 3, in select embodiments, process 100 for automatic dispensing of liquid cleaning solvents 16 may further comprise step 270 of tracking the vending machine location via asset tracking feature 96. The asset tracking feature 96 may be configured to locate the vending machine 10.

Referring now to FIG. 3, in select embodiments, process 100 for automatic dispensing of liquid cleaning solvents 16 may further comprise step 280 of accepting cashless payment options including credit card or mobile payments configured to provide convenience and case of use of the vending machine.

Referring to FIGS. 1-3, in select embodiments, process 100 for automatic dispensing of liquid cleaning solvents 16 may comprise: step 170 of displaying the plurality of containers 14 of the liquid cleaning solvent 16 inserted into vending machine 10 through transparent front window 66; step 180 of insulating inside 40 of vending machine 10 by providing injected foam cabinet 68; step 190 of maintaining a required temperature 72 inside of vending machine 10 via temperature control feature 70, wherein, the desired temperature may be configured to be set to maintain the liquid cleaning solvents 16 at their required temperature 72; step 200 of detecting leaks inside and from vending machine 10 via leak detection and containment system 74 configured to prevent and address spills or leaks promptly; step 210 of displaying prices, programming messages, machine status, product labels, or combinations thereof via a display monitor 76; step 220 of providing a user-friendly touchscreen interface 78 configured to display product information, prices, any necessary warnings or combinations thereof; step 230 of transporting each of the plurality of containers 14 of the liquid cleaning solvent 16 via elevator 80, where elevator 80 may be configured to transport each of the plurality of containers 14 from tray area 84 to collection box 86; step 240 of restricting the vertical movement of elevator 80 via blocking mechanism 88, where blocking mechanism 88 may be configured to mitigate the risk of theft through collection door 90 of the collection box 86 by securing the plurality of containers 14 of the liquid cleaning solvent 16 on the dispensing trays 18; step 250 of locking vending machine 10 via secure locking system 92, where secure locking system 92 may be configured to prevent unauthorized access and ensure safety of the containers 14 of the liquid cleaning solvent 16; step 260 of conducting surveillance of vending machine 10 and the plurality of containers 14 of the liquid cleaning solvents 16 automatically dispensed therefrom via surveillance system 94, where surveillance system 94 may be configured for security and monitoring purposes; step 270 of tracking the vending machine location via asset tracking feature 96, where the asset tracking feature 96 may be configured to locate the vending machine 10; and step 280 of accepting cashless payment options including credit card or mobile payments configured to provide convenience and ease of use of the vending machine.

Referring now to FIGS. 4-20, various embodiments of vending machine 10 are shown. Vending machine 10 may be for automatically dispensing of the plurality of containers 14 of liquid cleaning solvent 16. Vending machine 10 may be any size, shape, type, color, style or configuration of a vending machine that is configured for automatically dispensing of the plurality of containers 14 of liquid cleaning solvent 16. Vending machine 10 may be manufactured specifically for automatically dispensing of the plurality of containers 14 of liquid cleaning solvent 16, or vending machine 10 may be a current vending machine that is retrofitted and configured for automatically dispensing of the plurality of containers 14 of liquid cleaning solvent 16. Vending machine 10 may be made or manufactured by various vending machine manufacturers. In select embodiments, as shown herein, vending machine 10 may be a retrofitted vending machine from Jofemar USA of Doral, FL or Jofemar, S. A. of Navarra, Spain, like as those shown in U.S. Pat. Nos. 7,712,628, 8,887,951, 9,330,519, 11,986,106, each of which is incorporated here into in their entireties.

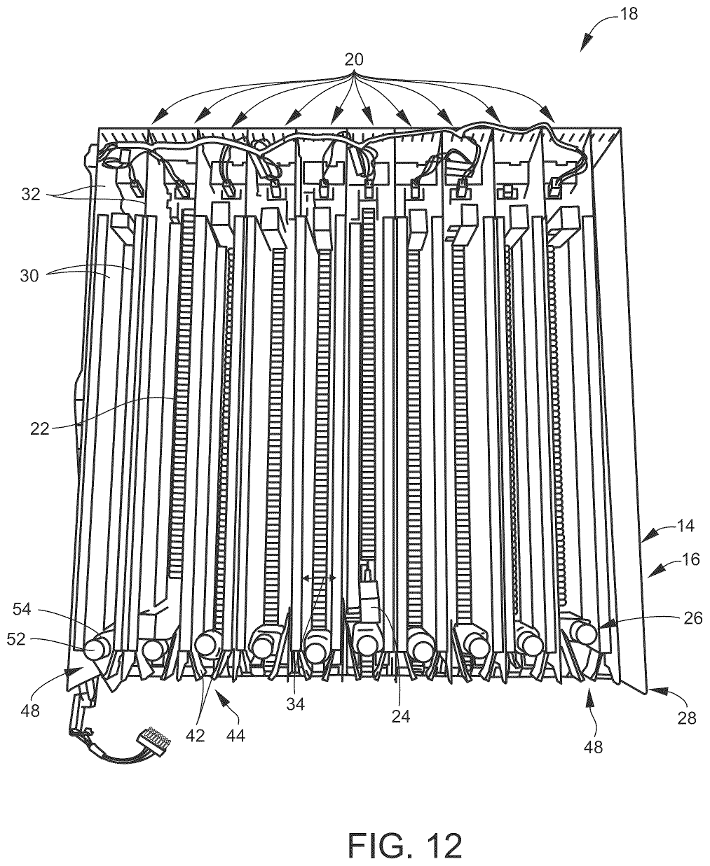

Vending machine 10 may generally include at least one dispensing tray 18 with at least one compartment 20. Vending machine 10 may include any number of dispensing trays 18. Various sizes of vending machine 10 may include various numbers of dispensing trays 18. In select embodiments, vending machine 10 may include 8 dispensing trays 18 or shelves. Each dispensing tray 18 may include any number of compartments 20 for providing various amounts of SKUs (stock keeping unit) inside of vending machine 10. In select embodiments of dispensing trays 18, seven compartments 20 may be included of single bottles or containers 14 of liquid cleaning solvent 16 (see FIGS. 4, 5, 9, 10, and 11). In other select embodiments of dispensing trays 18, ten compartments 20 may be included of single bottles or containers 14 of liquid cleaning solvent 16 (see FIGS. 12, 13 and 14). In other select embodiments of dispensing trays 18, ten compartments 20 may be included of a mix between single bottles or containers 14 of liquid cleaning solvent 16 and multi-packs 35 of multiple bottles or containers 14 of liquid cleaning solvent 16 (see FIGS. 6, 7 and 8). In select embodiments, like for a top dispensing tray 18, compartments 20 with multi-packs 35 may be included with multiple bottles or containers 14 of liquid cleaning solvent 16 stacked on top of each other, i.e. double the height of product in such compartments or SKUs. Each compartment 20 may include conveyor belt 22 with a single pushing block 24 (see FIGS. 6-14 and 18) or a plurality of pushing blocks 24 (see FIGS. 5-7 and 17). Each compartment 20 may be configured for holding the plurality of containers 14 of the liquid cleaning solvent 16 in vertical orientation 26 on conveyor belt 22. Pushing block 24 or the plurality of pushing blocks 24 may be configured to move the plurality of containers 14 of the liquid cleaning solvent 16 on the conveyor belt 22 out of front 28 of the corresponding compartment 20. This movement may be controlled by various motors and servos configured to dispense a single container 14 of the liquid cleaning solvent out of front 28 of each compartment 20. In order to hold the containers 14 of liquid cleaning solvent 16 in vertical orientation 26, each compartment 20 may include longitudinal spacer members 30 on each longitudinal side 32 of the compartments 20. The longitudinal spacer members 30 may be brackets affixed to each longitudinal side 32 of the compartments 20. The brackets may have straight edges or various contours to fit the shape and size of the containers 14 of liquid cleaning solvents 16. As such, longitudinal spacer members 30 may be sized, shaped and configured to match the size, shape and configuration of the container 14 of liquid cleaning solvent 16 being automatically dispensed in the corresponding compartment 20. As such, the longitudinal spacer members 30 on each longitudinal side 32 of the compartment 20 may be configured to center and hold the plurality of containers 14 of the liquid cleaning solvent 16 in vertical orientation 26 on conveyor belt 22 as they are moved out of the front 28 of the corresponding compartment 20. Wherein, vending machine 10 may be designed and configured to provide automatic dispensing of the plurality of the containers 14 of the liquid cleaning solvent 16.

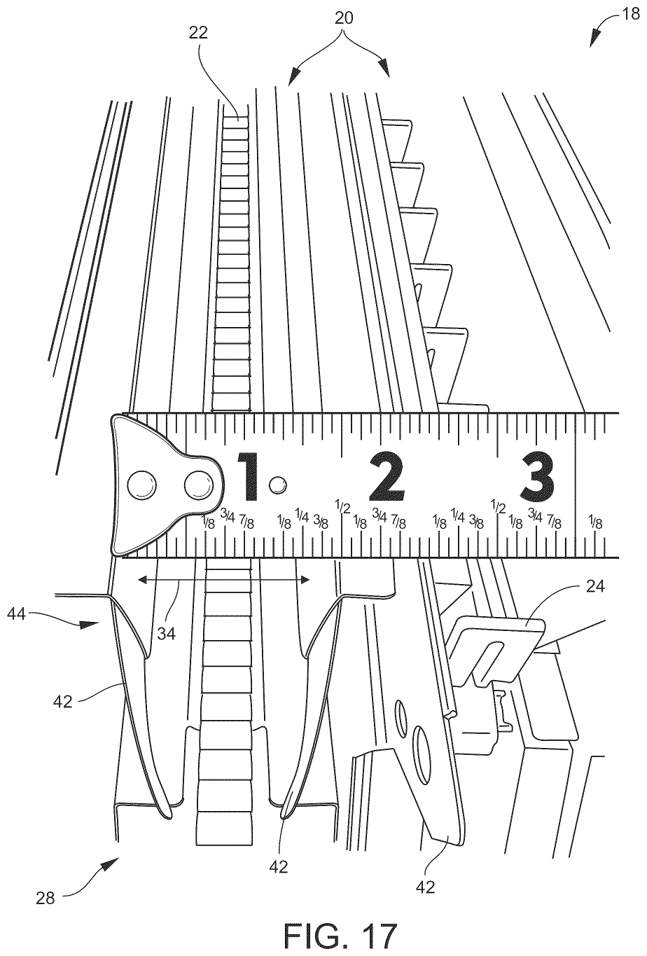

As best shown in FIGS. FIGS. 9, 10, 12, 13, 15, 16, and 17, one feature of vending machine 10 may be that at least one of the compartments 20 may include bottle width 34. Bottle width 34 may be between longitudinal spacer members 30 on each longitudinal side of the corresponding compartment 20. Bottle width 34 may be sized to hold containers 14 of liquid cleaning solvent 16 in vertical orientation 26 on conveyor belt 22 as the plurality of containers 14 of the liquid cleaning solvent 16 are moved out of front 28 of compartment 20 via conveyor belt 22 with pushing block 24 or a plurality of pushing blocks 24. Bottle width 34 may be sized slightly larger than containers 14 in the corresponding compartment 20 and may vary for each compartment 20 of each dispensing tray 18. As an example, and clearly not limited thereto, bottle width 34 may be sized to hold 10 ml, 15 ml, 30 ml, the like, and/or various combinations thereof, of various size and shapes of containers 14 for liquid cleaning solvent 16, like various glass (like amber), metal, or the like containers or small bottles of liquid cleaning solvent 16. As shown in FIG. 17, in select possibly preferred embodiments, and clearly not limited thereto, bottle width 34 between corresponding longitudinal spacer members 30 in compartment 20 may be approximately, 1.25 inches, 1.5 inches, and/or 1.75 inches. Having bottle width 34 of approximately 1.25 inches, 1.5 inches, and/or 1.75 inches may provide the proper spacing between corresponding longitudinal spacer members 30 in compartment 20 for holding the majority of the known 10 ml, 15 ml, and/or 30 ml containers 14 of liquid cleaning solvent 16 in vertical orientation 26. In addition, providing bottle width 34 between co corresponding longitudinal spacer members 30 in compartment 20 slight larger than containers 14 may prevent containers 14 from spinning during movement along conveyor 22 in compartment 20. This may allow the containers 14 to be loaded onto conveyor 22 in compartment 20 with the labels on containers 14 facing forward and ensure that the labels face forward during automatic dispensing of the loaded containers 14.

As shown in FIGS. 6-8, another feature of vending machine 10 may be that it can be configured for multi-packs 35 of the containers 14 of the liquid cleaning solvent 16. Each multi-pack 35 may include at least two containers 14 of the liquid cleaning solvent 16. The multi-packs 35 may include multiple containers 14 of the liquid cleaning solvent 16 packaged side-by-side and/or packaged with containers 14 stacked on top of one another (like for the top dispensing tray as shown in FIGS. 6-8). In select embodiments, multi-packs may include two containers 14 of liquid cleaning solvent 16 packaged side-by-side. Wherein, in select embodiments of vending machine 10, at least one of the compartments 20 may include package width 36 between the longitudinal spacer members 30 on each longitudinal side 32 of the corresponding compartment 20. Package width 36 may be sized to hold the plurality of the multi-packs 35 of the containers 14 of the liquid cleaning solvent 16 in vertical orientation 26 on conveyor belt 22 as the plurality of multi-packs 35 of the containers 14 of the liquid cleaning solvent 16 are moved out of front 28 of compartment 20 via the conveyor belt 22 with the pushing block 24 or a plurality of pushing blocks 24. Package width 36 may be sized slightly larger than multi-packs 35 in the corresponding compartment 20 and may vary for each compartment 20 of each dispensing tray 18. As an example, and clearly not limited thereto, package width 36 may be sized to hold two side-by-side 10 ml, 15 ml, 30 ml, the like, and/or various combinations thereof, of various size and shapes of containers 14 for liquid cleaning solvent 16, like various glass (like amber), metal, or the like containers or small bottles of liquid cleaning solvent 16. As shown in FIGS. 6-8, in select possibly preferred embodiments, and clearly not limited thereto, package width 36 between corresponding longitudinal spacer members 30 in compartment 20 may be approximately, 2.50 inches, 2.75 inches, 3.00, and/or 3.50 inches inches. Having package width 36 of approximately 2.50 inches, 2.75 inches, and/or 3.00, and/or 3.50 inches may provide the proper spacing between corresponding longitudinal spacer members 30 in compartment 20 for holding the majority of the known 10 ml, 15 ml, and/or 30 ml containers 14 of liquid cleaning solvent 16 in multi-packs 35 in vertical orientation 26 with containers 14 side-by-side.

Referring now specifically to FIG. 4, another feature of vending machine 10 may be the inclusion of refrigeration unit 38. Refrigeration unit 38 may be associated with vending machine 10 and may be positioned anywhere inside or around vending machine 10. Refrigeration unit 38 may be configured to refrigerate or cool inside 40 of vending machine 10. As such, refrigeration unit 38 may be configured to pre-cool the plurality of containers 14 of liquid cleaning solvent 16 inserted into vending machine 10 prior to vending machine 10 automatically dispensing the plurality of containers 14 of liquid cleaning solvent 16.

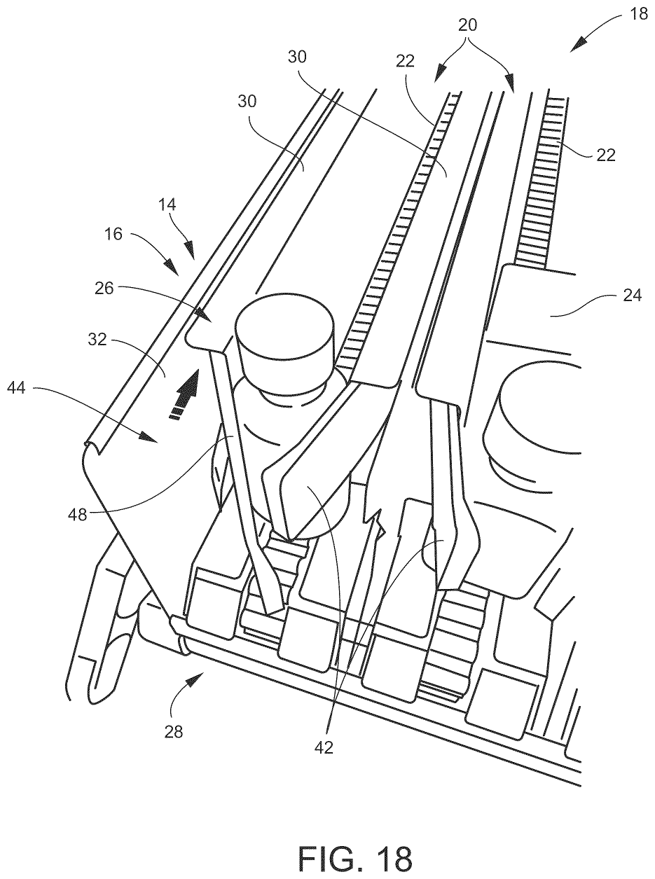

Another feature of vending machine 10 may be that the dispensing trays 18 with the at least one compartment 20 with conveyor belt 22 with pushing block 24, or multiple pushing blocks 24, may include spring retaining members 42. Spring retaining members 42 may be on each side 32 of the compartment 20 at distal end 44. Spring retaining members 42 on each side 32 of the compartment 20 at the distal end 44 may be configured to ensure the dispensing of single container 46 of liquid cleaning solvent 16, or a single multi-pack 35. In select embodiments, at least one of the spring retaining members 42 mounted on at least one of the sides 32 of the compartment 20 at distal end 44 may be magnetic spring retaining member 48. See FIGS. 6, 7, 18, 19 and 20. Magnetic spring retaining member 48 may be configured to magnetically mount to side 32 of compartment 20 at distal end 44, as shown in FIG. 18. Each of the at least one magnetic spring retaining member 48 may include magnet 50. Magnet 50 may be configured for magnetically mounting the magnetic spring retaining member 48 to the side 32 of the compartment 20 at distal end 44. Magnetic spring retaining member 48 may be added to certain vending machines 10 that do not include spring retaining members on the outer sides 32 of the outer compartments 20 of each dispensing tray 18. As such, magnetic spring retaining member 48 may be retrofitted onto such vending machines 10 to provide spring retaining members 42 on each side 32 of each compartment 20 at distal end 44. This may be critical for ensuring that single container 46 is dispensed from such outer compartments as two opposing spring retaining members 42 may be required in each compartment 20 for such small containers 14 or bottles normally associated with liquid cleaning solvent 16.

Still referring to FIG. 4, in select embodiments, vending machine 10 may further include a plurality of RFID (radio frequency identification) tags 52 and at least one RFID antenna 56. Each RFID tag 52 may be attached to one of the plurality of containers 14 of the liquid cleaning solvent 16. RFID tags 52 may be attached anywhere on container 14. In select possibly preferred embodiments, as shown in the Figures, each RFID tag 52 may be attached to cap 54 of container 14 of liquid cleaning solvent 16. Each of the at least one RFID antennas 56 may be mounted above one of the dispensing trays 18 in vending machine 10. As shown in FIG. 4, in select embodiments, and clearly not limited thereto, RFID antenna 56 may be positioned below top 58 of vending machine 10 for the uppermost dispensing tray and on underside 60 of each dispensing tray 18 for all of the other dispensing trays. Each of the at least one RFID antennas 56 may be configured to track the plurality of containers 14 of the liquid cleaning solvent 16 in the dispensing tray 18 via the RFID tags 52 attached to each of the plurality of containers 14 of the liquid cleaning solvent 16. Wherein, in select embodiments, vending machine 10 may be configured to track inventory 62 of the plurality of containers 14 of the liquid cleaning solvent 16 inserted into vending machine 10 and automatically dispensed from vending machine 10. Wherein, in select possibly preferred embodiments, vending machine 10 may be configured to provide real-time inventory tracking 64 of plurality of containers 14 of the liquid cleaning solvent 16 inserted into vending machine 10 and automatically dispensed from vending machine 10 via RFID antennas 56 and RFID tags 52. The provided real-time inventory tracking 64 may be configured to providing efficient restocking and/or for preventing stockouts. Real-time inventory tracking 64 via RFID antennas 56 and RFID tags 52 may provide for inventory tracking of liquid cleaning solvents 16, like real-time inventory tracking 64 via RFID antennas 56 and RFID tags 52 may provide for inventory tracking of alkyl nitrates. In select embodiments of vending machine 10, 1 to 2 units of RFID antennas 56 may be mounted inside vending machine 10 on the ceiling or under top 58 of vending machine 10. Whereby the signal from RFID antennas 56 may point down to read RFID tags 52 on containers 14 of liquid cleaning solvent 16, like on 10 ML, 15 ML, and/or 30 ML glass bottles and multi-packs 35 of liquid cleaning solvents 16 on dispensing tray 18 below. In select embodiments of vending machine 10, 1 to 2 units of RFID antennas 56 may be mounted to underside 60 of each dispensing tray 18, like on underside 60 of 8 dispensing trays. Whereby, the signal from each RFID antenna 56 will point down to read RFID tags 52 on containers 14 of liquid cleaning solvent 16, like on 10 ML, 15 ML, and/or 30 ML glass bottles and multi-packs 35 of liquid cleaning solvents 16 on dispensing trays 18 below. In select embodiments, RFID tags 52 may be affixed to each bottle or container 14 of liquid cleaning solvents 16 (i.e., alkyl nitrate) on the side of container 14, like affixed on the side of the glass or metal bottle. In select embodiments, RFID tags 52 affixed to the bottle cap 54 as way of an RFID tag FLAG, where the bottles can contain any and/or all of the alkyl nitrates disclosed herein. In select embodiments, real-time inventory tracking 64 via RFID antennas 56 and RFID tags 52 may include, but is not limited to: AdvanCloud Kconn software, AdvanNet software, RFID tag in-coding, RFID shelfs, RFID readers, RFID multiplexers, RFID splitters, RFID connection boards, and/or RFID antennas from Kconn Technologies of Barcelona, Spain. In select embodiments, real-time inventory tracking 64 via RFID antennas 56 and RFID tags 52 may include, but is not limited to: proximity nearfield UHF RFID antennas (i.e. True NearField RAIN RFID Antenna Series, A111 5NearField/Short Range UHF RFID Antenna, A1130 NearField/Short Range UHF RFID Antenna, A1163 NearField/Short Range UHF RFID Antenna, A5020 NearField/Short Range UHF RFID Antenna, A1001 NearField/Short Range UHF RFID Antenna, and/or A1030 NearField/Short Range UHF RFID Antenna) from Times-7 of Lower Huytt, New Zealand. In select possibly preferred embodiments, real-time inventory tracking 64 via RFID antennas 56 and RFID tags 52 may include, but is not limited to the A1130 True NearField Antenna (FCC/ETSI) from Times-7 of Lower Huytt, New Zealand. The Times-7 A1130 True NearField Antenna may be explicitly designed for applications, which require near zone only tag detection or involve metals, liquid, and other challenging materials. With hardly any far-field components and no surface dead spots, the A1130 antenna as RFID antenna 56 may offer reliable tag reads of RFID tags 52 within a very constricted read zone. Integrated mounting holes on the rear side of the A1130 True NearField Antenna may be provided, which can be drilled through for using mounting screws. Additionally, the A1130 True NearField Antenna may be provided with an optional self-adhesive rubber feet kit to stop the antenna from slipping. With the A1130 True NearField Antenna as RFID antenna 56 positioned in the confined read area of vending machine 10, RFID antenna 56 may be configured to track precisely plurality of containers 14 of liquid cleaning solvent 16 and nothing else. RFID antenna 56 being a true NearField antennas may provide a highly focused RF field to avoid unwanted stray items which might otherwise confuse or clutter tracking data and reporting. With the A1130 True NearField Antennas as RFID antennas 56, these are real NearField antennas ideal for strictly confined reading over a sharply defined area (unlike other near-field antennas which are often far-field antennas with low gain). The A1130 True NearField Antennas as RFID antennas 56 may provide full surface read coverage without missing a single item. Many RFID antennas have zones where tracked items are partially or totally unreadable, especially near the corners. True NearField antennas as RFID antennas 56 may read items absolutely anywhere on their surface, while not reading items outside the edges or more than several centimeters above their surface. To achieve the most highly defined read zone, near-field tags may also be used for RFID tags 52 to track items in vending machine 10, like plurality of containers 14 of liquid cleaning solvent 16.

Still referring specifically to FIG. 4, in select embodiments, vending machine 10 may further include transparent front window 66. Transparent front window 66 may be configured for displaying the plurality of containers 14 of the liquid cleaning solvent 16 inserted into vending machine 10.

Still referring specifically to FIG. 4, in select embodiments, vending machine 10 may further include injected foam cabinet 68. Injected foam cabinet 68 may be configured to insulate inside 40 of vending machine 10.

Still referring specifically to FIG. 4, in select embodiments, vending machine 10 may further include temperature control feature 70. Temperature control feature 70 may be configured to maintain required temperature 72 inside of vending machine 10. Wherein the desired temperature may be configured to be set to maintain the liquid cleaning solvents 16 at their required temperature 72.

Still referring specifically to FIG. 4, in select embodiments, vending machine 10 may further include leak detection and containment system 74. Leak detection and containment system may be configured to detect leaks inside and from vending machine 10. Leak detection and containment system 74 may be configured to prevent and address spills or leaks promptly.

Still referring specifically to FIG. 4, in select embodiments, vending machine 10 may further include display monitor 76. Display monitor 76 may be configured to display prices, programming messages, machine status, product labels, the like, and/or combinations thereof. Display monitor 76 may be any size or shape of display monitor. Display monitor may be built into the front of vending machine 10, as shown in FIG. 1, or it may be attached externally on or around vending machine 10. Display monitor 76 may provide digital signage for vending machine 10. In select embodiments, the digital signage of display monitor 76 may be mounted/attached on the top, and/or the right or left of vending machine 10. In select embodiments, the digital signage of display monitor 76 may be mounted in a separate cabinet to the right side, left side, and/or top of vending machine 10. As exampled, and clearly not limited thereto, the digital signage of display monitor 76 may include: a monitor and digital signage software solution from Navori Labs of Lausanne, Switzerland (Navori S. A.); and/or digital signage and software from OptiSigns of Houston, TX.

Still referring to FIG. 4, in select embodiments, vending machine 10 may further include user-friendly touchscreen interface 78. User-friendly touchscreen interface may be configured to display product information, prices, any necessary warnings, the like, and/or combinations thereof. User-friendly touchscreen interface may be built into display monitor 76 or it may be a separate feature of vending machine 10.

Still referring to FIG. 4, in select embodiments, vending machine 10 may further include elevator 80. Elevator 80 may be configured to transport dispensed containers 82 of liquid cleaning solvent 16 from tray area 84 to collection box 86.

Still referring to FIG. 4, in select embodiments, vending machine 10 may further include blocking mechanism 88. Blocking mechanism 88 may be configured to restrict the vertical movement of elevator 80. Blocking mechanism 88 may be configured to mitigate the risk of theft through collection door 90 of collection box 86 by securing the plurality of containers 14 of liquid cleaning solvent 16 on dispensing trays 18.

Still referring to FIG. 4, in select embodiments, vending machine 10 may further include secure locking system 92. Secure locking system 92 may be configured to lock vending machine 10. Secure locking system 92 may be configured to prevent unauthorized access and ensure safety of the stored containers 14 of liquid cleaning solvent 16.

Still referring to FIG. 4, in select embodiments, vending machine 10 may further include surveillance system 94. Surveillance system 94 may be configured to conduct surveillance of vending machine 10 and the plurality of containers 14 of liquid cleaning solvents 16 automatically dispensed therefrom. Surveillance system 94 may be configured for security and monitoring purposes. In select embodiments, surveillance system 94 may include mounting bracket 95, camera, multiple cameras, 365 degree fish-eye style cameras, multi-sensor cameras, the like, and/or combinations thereof. As examples and clearly not limited thereto, surveillance system 94 of vending machine 10 may utilize software and/or hardware from the following: the V200 body camera and/or VideoManager EX from Motorola Solutions of Charlotte, NC; an intelligent cloud video surveillance system with an all-in-one open ecosystem and/or a 20 MP outdoor IP Multisensor Camera from OpenEye of Liberty Lake, Washington; a video surveillance system, like the Axis P12 modular camera series, panoramic cameras, Single-sensor cameras, Q6100-E network camera, Axis FA Modular Camera Series, Axis F2135-RE Fisheye Sensor, Axis P1245 Mk II Modular Standard Camera, Axis P1265 Mk II Modular Pinhole Camera, Axis P1275 Mk II Modular Varifocal Dome Camera, Axis M4328-P Panoramic Camera,/andor Axis M43 Series cameras from Axis Communications of Lund, Sweden; security cameras from Rhombus Systems of Sacramento, California; cloud physical security from Verkada of San Mateo, Ca; a security camera from Lorex of Markham, Canada; security camera system from HikVision of Hangzhou, Zhijiaang in China; and/or combinations thereof. In select embodiments, a Non-AI machine learning camera for surveillance may be mounted above vending machine 10. In select embodiments, more than one 365 Fish-eye camera and/or multi sensor camera units may be mounted on an L-shaped mounting bracket 95, like an aluminum metal truss or metal electrical conduit pipe with the height of 8 ft to 10 ft from the floor. In select embodiments, mounting bracket 95 may be an L-shaped aluminum metal truss or metal electrical conduit pipe that may be attached to the back of vending machine 10 for surveillance system 94. In select embodiments, mounting bracket 95 may be an L-shaped aluminum metal truss or metal electrical conduit pipe that may be attached to its own freestanding base positioned behind vending machine 10 for surveillance system 94. In select embodiments, more than one unit of a 365 Fish-eye camera and/or multi sensor cameras may be mounted on mounting bracket 95, like on an L-shaped aluminum metal truss or metal electrical conduit pipe 8 ft to 10 ft from the floor, and may extend from the back of vending machine 10 approximately 4 ft to 6 ft from the back of the machine to be positioned past the front door of the refrigerated vending machine 10. With this position, the 365 Fish-eye camera and/or multi sensor cameras may capture the live video stream of a customer purchasing an item. With this position, the 365 Fish-eye camera and/or multi sensor cameras may capture the live video stream of the individual vending shelves being restocked by a restocking specialist. With this position, the 365 Fish-eye camera and/or multi sensor cameras may capture the live video stream of a vending machine mechanic servicing the machine. With this position, the 365 Fish-eye camera and/or multi sensor cameras may capture the live video stream of the machine being stolen. In select embodiments of surveillance system 94, 365 Fish-eye camera and multi sensor cameras (non-AI machine learning cameras) may be mounted on the back of vending machine 10, or an Al machine learning camera for surveillance may be mounted on the back of vending machine 10. With this position, the 365 Fish-eye camera and/or cameras may capture the live video stream of the back of vending machine 10 to the wall that its positioned against. With this position, the 365 Fish-eye camera and/or cameras may capture the live video stream of vending machine 10 being unplugged from the locations electrical outlet. In select embodiments of surveillance system 94, a compact and discreet indoor modular camera or cameras may be used. These cameras may be provided in various sensor sizes, they may provide easy and flexible installation, the may have a detachable cable up to 15 m, they may provide support for advanced analytics, and they may have object analytics pre-installed. In select embodiments a non-AI machine learning camera for surveillance may be mounted on the back of each dispensing tray 18 within vending machine 10. In select embodiments, AI machine learning cameras for surveillance may be mounted on the back of each dispensing tray 18 within vending machine 10. With this position, a 365 Fish-eye camera and/or micro pinhole cameras may capture the live video stream products vending from each shelf. With this position, a 365 Fish-eye camera and/or micro pinhole cameras may capture the live video stream products inventory levels per shelf. In select embodiments of surveillance system 94, non-AI machine learning cameras for surveillance may be mounted within vending machine 10 attached to elevator 80, or AI machine learning cameras for surveillance may be mounted within vending machine 10 attached to elevator 80. With this position, a 365 Fish-eye camera and/or micro pinhole cameras may capture the live video stream of products from the front of the dispensing trays 18 scanning the products as the elevator 80 ascends and descends during a purchase or machine test. In select embodiments, surveillance system 94 of vending machine 10 may use non AI cameras. In other select embodiments, surveillance system 94 of vending machine 10 may use AI cameras. In other select embodiments, surveillance system 94 of vending machine 10 may include a combination of non AI cameras and AI enabled cameras.

Still referring to FIG. 4, in select embodiments, vending machine 10 may further include asset tracking feature 96. Asset tracking feature 96 may be configured to track the location of vending machine 10. Asset tracking feature 96 may be configured to locate vending machine 10 if vending machine 10 is moved from its location. Asset tracking feature 96 may provide real-time GPS tracking of vending machine 10. In addition, in select embodiments, asset tracking feature 96 may also provide remote reboot of vending machine 10, remote reboot of any credit card readers or the like on vending machine 10, and/or door open door close sensors on vending machine 10. In select embodiments, asset tracking feature 96 may include, but is not limited to: DLP wireless network-architecture, Hercules Shields, NTrap™ ethernet ports for physical tampering detection, GPS tracking, Hercules Portal, a High Gain Antenna (ANT-H-GAIN-Z part number), DPL network architecture, a puck antenna (ANT-P-TH part number, and/or ANT-P-GPS-TH part number), and/or a brick antenna (ANT-B-TH part number, ANT-B-MG part number) from DPL Wireless of Moncton, NB, Canada. In select embodiments, asset tracking feature 96 may include DPL Wireless's 4G LTE CAT-1 Hercules modem configured for reliable wireless and remote reboot of vending machine 10, which may offer reliable wireless for all self-serve applications from standard vending machines In select embodiments, asset tracking feature 96 may include Hercules Shield from DPL wireless for GPS tracking of vending machine 10 configured to transmit its GPS position in real-time and its built-in battery enables it to continue transmitting its location for up to 7 days after being disconnected from its power source. In select embodiments, asset tracking feature 96 may include Hercules Portal from DPL wireless configured to track the GPS position of vending machine 10 in real-time from the security tab of the Hercules Portal, which may be configured to hare the forensic view with local law enforcement to help catch crooks and recover stolen assets, and/or view alarms for tilting and vibration, power interruptions, the like, etc. In select embodiments, asset tracking feature 96 may include the optional restart accessory of the Hercules Portal from DPL Wireless configured for remote reboot to enables remote reboot of vending machine 10 and its components even if their operating system is frozen.

Still referring to FIG. 4, in select embodiments, vending machine 10 may further include cashless payment feature 98. Cashless payment feature 98 may be configured to accept cashless payment options including credit card, mobile payments and/or the like. Cashless payment feature 98 may be configured to provide convenience and ease of use of vending machine 10. However, the disclosure is not so limited, and any various forms of payment may be included with vending machine 10. In some embodiments, vending machine 10 may include cash and cashless payment features. In other select embodiments, vending machine 10 may include just cash payment features with no cashless. In other select embodiments, vending machine 10 may include no cash options. In select embodiments, vending machine 10 can also take cash payments with a bill recycler that can give change in bills or with coinage utilizing a coin mechanism. As an example, and clearly not limited thereto, in select embodiments vending machine 10 may include a modernized banknote validator, like a Talos™ note validator from Crane Payment Innovations of Malvern, PA. In other select embodiments, vending machine 10 may include a payment option of a stored value card, like as used with the laundry industry. As an example, and clearly not limited thereto, in select embodiments, vending machine 10 may include a bill acceptor from Coinco of St. Louis, MO, a bill acceptor with US dollars 1, 100 Bill Stacker that accepts 50's and 100's from Laundroworks or Mitech Integrated Systems, Inc of Ontario, Canada.

In use, vending machine 10 and process 100 for automatically dispensing liquid cleaning solvents 16 may have front transparent window 66 or panel through which cold or pre-cooled containers 14 of liquid cleaning solvents 16 in an extraction system can be viewed for selection. Pre-cooled solvent containers 14 may be aligned with the unitary extraction system so that the pre-cooled containers 14 can be viewed where vendable containers 14 in the unitary extraction system are depleted. Continuous advertisement may be provided in the form of the cold solvents containers themselves which are viewed through the transparent front window 66 that may be a double pained gas filed panel. An extraction system designed for dispensing the small containers/bottles 14 of the liquid cleaning solvents 16 may be provided in vending machine 10. The small containers/bottles 14 may be stored in respective compartments 20 on a series of dispensing trays 18 featuring a centrally open laminar base. A conveyor belt 22 equipped with multiple toothed projections may be in the central opening of the laminar base. The unitary extraction system for dispensing products may be characterized by a singular pusher block 24 or a series of pusher blocks 24 affixed to conveyor belt 22 that possesses numerous projections. This attachment may be realized through a rotary arm of the pusher, constrained by a spring, with its lower end situated between two curved projections of the conveyor belt 22. The pusher block 24 or blocks 24 remain in its initial position against the innermost product within the corresponding compartment of the corresponding dispensing tray 18. At the end of each compartment 20 exhibits a pair of lateral metal strips, or spring retaining members 42, converging toward the center in its upper part. These strips keep the containers/bottles 14 secure until vended.

The refrigerated solvents automated dispending vending machine 10 may feature elevator 80 designed to transport products from the tray area 84 to the collection box 86. The unique configuration of this elevator 80 may enhance the machine's product dispensing capacity and may allow for the storage of a greater number of products, ready for subsequent dispensing.

The refrigerated solvents automated dispensing vending machine 10 may also feature an elevator system equipped with blocking mechanism 88. This blocking mechanism 88 may restrict the vertical movement of the elevator 80, effectively preventing unauthorized access to the tray area 84. This, in turn, mitigates the risk of theft by securing the products on the dispensing trays 18 through the dispensed product collection door 90.

One version of the refrigerated solvents automated dispensing vending machine 10 may include elevator 80 that also functions as collection box 86 from which users retrieve their selected products. With this version this design eliminates the necessity for additional components to transport products from elevator 80 to collection box 86. Consequently, the overall available space within vending machine 10 may be optimized, providing increased utility for product storage.

In select embodiments, a soft elevator delivery system may be included.

In select embodiments, a waist high dispensing area may be included.

In select embodiments, the machine and process may be configured to be ADA Compliant.

In select embodiments, an energy saving feature may be included that is configured to turn off any LED cabin lights during non-operational periods.

In select embodiments, programmable health and safety controls may be included as well as expiration date per selection.

In select embodiments, a continuous self-testing & diagnosis failure incident report feature may be included.

In select embodiments, a sturdy all steel constructed cabinet may be included with corrosion-resistant & rust proofing treatment.

In select embodiments, injected foam cabinet 68 may be included that may be configured to assure the best refrigeration using low power consumption by the cooling unit.

In select embodiments, a complete accounting data storage feature may be included that is configured to be retrievable via machine programming display or DEX/UCS/RS232 ports.

In select embodiments, LCD screen displays (display monitor 76) may be included that can be configured to display prices, programming messages, machine status, the like, and/or combinations thereof.

In select embodiments, a first in first out (FIFO) delivery dispensing integrated PDSS (product detection sensors system) may be included.

In select embodiments, the machine and/or process may include guaranteed delivery and/or configured to eliminate double vends.

In select embodiments, an anti-pick lock cylinder may be included that can be combined with a 3-point door locking system.

In select embodiments, temperature control 70 may be included that can be integrated into the refrigeration unit 38 to maintain liquid cleaning solvents 16 at required temperature 72, ensuring product integrity and safety.

In select embodiments, product storage may include adjustable shelves or compartments to accommodate solvent containers of various sizes (e.g., 10 ml, 15 ml, 30 ml).

In select embodiments, for security secure locking system 92 may be included to prevent unauthorized access and ensure the safety of the stored containers 14 of liquid cleaning solvents 16.

In select embodiments, for a dispensing mechanism, a conveyor or spirals may be configured to move products to a dispensing point, allowing for a smooth and controlled delivery process.

In select embodiments, for a payment system, cashless payment options 98 may be included, such as credit card or mobile payments, providing convenience and ease of use for customers.

In select embodiments, for inventory tracking, RFID (Radio-Frequency Identification) technology (RFID tags 52 and RFID antennas 56) for providing real-time inventory tracking 64 may be included and configured for providing efficient restocking and preventing stockouts.

In select embodiments, for safety features, a leak detection and containment system 74 may be included and may be configured to prevent and address spills or leaks promptly.

In select embodiments, clear product labeling with safety instructions and information may be included. Generally speaking, liquid cleaning solvents, as used herein, may refer to glass and metal containers or small bottles of nitrite based solvent cleaners. The containers or small bottles of liquid cleaning solvents, as disclosed herein, may be sold as commercial solvent cleaners only and they are intended for cleaning use only. The misuse of these products is expressly forbidden as inhalants and deliberate misuse of these products is likely illegal. Use of these products for human consumption is banned by the US Consumer Product Safety Commission. By purchasing or vending of these liquid cleaning solvents products, the user agrees not to use them in a manner that is inconsistent with the manufacturers label. Most embodiments of these products do not contain amyl nitrite or butyl nitrite. In select possibly preferred embodiments of these liquid cleaning solvents products, they contain highly pure isobutyl nitrite, alkyl nitrites, cyclohexyl nitrite or hexyl nitrites only. The misuse or abuse of any nitrite based solvent cleaner combined with prescription drugs can cause a sever drop in blood pressure and may even result in death, as such the buyer will be warned not to mix nitrites and prescription drugs. The containers or small bottles of liquid cleaning solvent may contain warnings against inhaling the product and should only be used in accordance to the label. These liquid cleaning solvents products may not be sold for human consumption in accordance with CPSA, 15 USC 2051-2084, at 2057a, 2057b and 2068, and these products may not be for sale to minors.

In select embodiments, for a user Interface, a user-friendly touchscreen interface 78 may be included and configured to display product information, pricing, and/or any necessary warnings.

In select embodiments, emergency contact information may be prominently displayed for customer assistance.

In select embodiments, compliance with regulations may include strict adherence to local and federal regulations regarding the sale and dispensing of solvents. This may include age verification systems to ensure compliance with legal age restrictions.

In select embodiments, vending machine 10 and/or process 100 for automatic dispensing of liquid cleaning solvents 16 may work with vending machine manufacturers or customization services to adapt a standard refrigerated vending machine to meet specific solvent dispensing requirements.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A process for automatic dispensing of a liquid cleaning solvent comprising:
providing a plurality of containers of the liquid cleaning solvent;
manufacturing a vending machine configured for automatically dispensing said plurality of containers of the liquid cleaning solvent;
inserting the plurality of containers of the liquid cleaning solvent into the manufactured vending machine; and
automatically dispensing the plurality of containers of the liquid cleaning solvent via the manufactured vending machine.

2. The process for automatic dispensing of the liquid cleaning solvent of claim 1, wherein the manufacturing the vending machine configured for automatically dispensing said plurality of containers of the liquid cleaning solvent including adding a refrigeration unit to the manufactured vending machine, where the refrigeration unit is configured to refrigerate an inside of the manufactured vending machine; and
wherein, the process for automatic dispensing of the liquid cleaning solvent further including pre-cooling the plurality of containers of the liquid cleaning solvent inserted into the manufactured vending machine prior to the automatically dispensing the plurality of containers of the liquid cleaning solvent.

3. The process for automatic dispensing of the liquid cleaning solvent of claim 1, wherein the manufacturing the vending machine configured for automatically dispensing said plurality of containers of the liquid cleaning solvent including creating at least one dispensing tray with at least one compartment with a conveyor belt with a pushing block, each of the at least one compartment is configured for holding the plurality of containers of the liquid cleaning solvent in a vertical orientation on the conveyor belt; and
whereby the automatically dispensing the plurality of containers of the liquid cleaning solvent via the manufactured vending machine including moving the plurality of containers of the liquid cleaning solvent in the vertical orientation out of the front of each of the at least one compartment via the conveyor belt with the pushing block in each of the at least one compartment.

4. The process for automatic dispensing of the liquid cleaning solvent of claim 3, wherein the creating of the at least one dispensing tray with the at least one compartment with a conveyor belt with the pushing block including affixing longitudinal spacer members on each longitudinal side of each of the at least one compartment on the dispensing trays, wherein the longitudinal spacer members on each longitudinal side of each of the at least one compartment are configured to center and hold the plurality of containers of the liquid cleaning solvent in the vertical orientation on the conveyor belt as they are moved out of the front of each of the at least one compartment; and
wherein the moving of the plurality of containers of the liquid cleaning solvent in the vertical orientation out of the front of each of the at least one compartment via the conveyor belt with the pushing block including holding the plurality of containers of the liquid cleaning solvent in the vertical orientation via longitudinal spacer members while moving on the conveyor belt out of the front of each of the at least one compartment.

5. The process for automatic dispensing of the liquid cleaning solvent of claim 4, wherein at least one of the at least one compartment including a bottle width between the longitudinal spacer members on each longitudinal side of each of the at least one compartment, where the bottle width is sized to hold the plurality of containers of the liquid cleaning solvent in the vertical orientation on the conveyor belt as the plurality of containers of the liquid cleaning solvent are moved out of the front of each of the at least one compartment via the conveyor belt with the pushing block in each of the at least one compartment.

6. The process for automatic dispensing of the liquid cleaning solvent of claim 4, wherein the plurality of containers of the liquid cleaning solvent including a plurality of multi-packs of the plurality of containers of the liquid cleaning solvent, each multi-pack including two of the plurality of containers of the liquid cleaning solvent packaged side-by-side; and
wherein at least one of the at least one compartment including a package width between the longitudinal spacer members on each longitudinal side of each of the at least one compartment, where the package width is sized to hold the plurality of the multi-packs of the plurality of containers of the liquid cleaning solvent in the vertical orientation on the conveyor belt as the plurality of the multi-packs of the plurality of containers of the liquid cleaning solvent are moved out of the front of each of the at least one compartment via the conveyor belt with the pushing block of in each of the at least one compartment.

7. The process for automatic dispensing of the liquid cleaning solvent of claim 3, wherein the creating of the at least one dispensing tray with the at least one compartment with the conveyor belt with the pushing block including mounting spring retaining members on each side of each of the at least one compartment at a distal end;
whereby the automatically dispensing the plurality of containers of the liquid cleaning solvent via the manufactured vending machine including ensuring the dispensing of a single container of the liquid cleaning solvent via the spring retaining members mounted on each side of each of the at least one compartment at the distal end;
wherein at least one of the spring retaining members mounted on at least one of sides of each of the at least one compartment at the distal end is a magnetic spring retaining member configured to magnetically mount to the side of each of the at least one compartment at the distal end; and
wherein, the mounting the spring retaining members on each side of each of the at least one compartment at the distal end including magnetically mounting the at least one magnetic spring retaining member on at least one of the sides of each of the at least one compartment at the distal end.

8. The process for automatic dispensing of the liquid cleaning solvent of claim 1 further comprising tracking an inventory of the plurality of containers of the liquid cleaning solvent inserted into the vending machine and automatically dispensed from the vending machine;
wherein the tracking the inventory of the plurality of containers of the liquid cleaning solvent inserted into the vending machine and automatically dispensed from the vending machine including:
attaching an RFID tag to each of the plurality of containers of the liquid cleaning solvent;
mounting an RFID antenna above each dispensing tray provided in the vending machine, the RFID antenna is configured to track the plurality of containers of the liquid cleaning solvent in the dispensing tray via the RFID tags attached to each of the plurality of containers of the liquid cleaning solvent; and
providing real-time inventory tracking of the plurality of containers of the liquid cleaning solvent inserted into the vending machine and automatically dispensed from the vending machine via the RFID antenna and the RFID tags, the provided real-time inventory tracking is configured to providing efficient restocking and preventing stockouts.

9. The process for automatic dispensing of the liquid cleaning solvent of claim 1 further comprising:
displaying the plurality of containers of the liquid cleaning solvent inserted into the vending machine through a transparent front window;
insulating the inside of the vending machine by providing an injected foam cabinet;
maintaining a required temperature inside of the vending machine via a temperature control feature, wherein the required temperature is configured to be set to maintain the liquid cleaning solvent at the required temperature of the liquid cleaning solvent;
detecting leaks inside and from the vending machine via a leak detection and containment system configured to prevent and address spills or leaks promptly;
displaying prices, programming messages, machine status, product labels, or combinations thereof via a display monitor;
providing a user-friendly touchscreen interface configured to display product information, prices, any necessary warnings or combinations thereof;
transporting each of the plurality of containers of the liquid cleaning solvent via an elevator, configured to transport each of the plurality of containers from a tray area to a collection box;
restricting the vertical movement of the elevator via a blocking mechanism configured to mitigate a risk of theft through a collection door of the collection box by securing the plurality of containers of the liquid cleaning solvent on the dispensing trays;
locking the vending machine via a secure locking system configured to prevent unauthorized access and ensure safety of the plurality of containers of the liquid cleaning solvent;
conducting surveillance of the vending machine and the plurality of containers of the liquid cleaning solvent automatically dispensed therefrom via a surveillance system configured for security and monitoring purposes;
tracking the vending machine location via an asset tracking feature configured to locate the vending machine;
accepting cashless payment options including credit card or mobile payments configured to provide convenience and ease of use of the vending machine; or
combinations thereof.

10. The process for automatic dispensing of the liquid cleaning solvent of claim 1 further comprising:
displaying the plurality of containers of the liquid cleaning solvent inserted into the vending machine through a transparent front window;
insulating the inside of the vending machine by providing an injected foam cabinet;
maintaining a required temperature inside of the vending machine via a temperature control feature, wherein the required temperature is configured to be set to maintain the liquid cleaning solvent at the required temperature of the liquid cleaning solvent;
detecting leaks inside and from the vending machine via a leak detection and containment system configured to prevent and address spills or leaks promptly;
displaying prices, programming messages, machine status, product labels, or combinations thereof via a display monitor;
providing a user-friendly touchscreen interface configured to display product information, prices, any necessary warnings or combinations thereof;
transporting each of the plurality of containers of the liquid cleaning solvent via an elevator, configured to transport each of the plurality of containers from a tray area to a collection box;
restricting the vertical movement of the elevator via a blocking mechanism configured to mitigate a risk of theft through a collection door of the collection box by securing the plurality of containers of the liquid cleaning solvent on the dispensing trays;
locking the vending machine via a secure locking system configured to prevent unauthorized access and ensure safety of the stored solvents;
conducting surveillance of the vending machine and the plurality of containers of the liquid cleaning solvent automatically dispensed therefrom via a surveillance system configured for security and monitoring purposes;
tracking the vending machine location via an asset tracking feature configured to locate the vending machine; and
accepting cashless payment options including credit card or mobile payments configured to provide convenience and ease of use of the vending machine.

11. A process for automatic dispensing of a liquid cleaning solvent comprising:
providing a plurality of containers of the liquid cleaning solvent, wherein the plurality of containers of the liquid cleaning solvent including single bottles of the liquid cleaning solvent and a plurality of multi-packs of the plurality of containers of the liquid cleaning solvent, each multi-pack including two of the plurality of containers of the liquid cleaning solvent packaged side-by-side:
manufacturing a vending machine configured for automatically dispensing said plurality of containers of the liquid cleaning solvent including:
adding a refrigeration unit to the manufactured vending machine, where the refrigeration unit is configured to refrigerate an inside of the manufactured vending machine;
creating at least one dispensing tray with at least one compartment with a conveyor belt with a pushing block, each of the at least one compartment is configured for holding the plurality of containers of the liquid cleaning solvent in a vertical orientation via longitudinal spacer members while moving on the conveyor belt, wherein each of the at least one compartment on the dispensing trays created includes a longitudinal spacer member on each longitudinal side of each of the at least one compartment, wherein the longitudinal spacer members on each longitudinal side of each of the at least one compartment are configured to center and hold the plurality of containers of the liquid cleaning solvent in the vertical orientation on the conveyor belt as they are moved out of the front of each of the at least one compartment, wherein:
at least one of the at least one compartment including a bottle width between the longitudinal spacer members on each longitudinal side of each of the at least one compartment, where the bottle width is sized to hold the plurality of containers of the liquid cleaning solvent in the vertical orientation on the conveyor belt as the plurality of containers of the liquid cleaning solvent are moved out of the front of each of the at least one compartment via the conveyor belt with the pushing block; and
at least one of the at least one compartment including a package width between the longitudinal spacer members on each longitudinal side of each of the at least one compartment, where the package width is sized to hold the plurality of the multi-packs of the plurality of containers of the liquid cleaning solvent in the vertical orientation on the conveyor belt as the plurality of the multi-packs of the plurality of containers of the liquid cleaning solvent are moved out of the front of each of the at least one compartment via the conveyor belt with the pushing block;
mounting spring retaining members on each side of each of the at least one compartment at a distal end, wherein at least one of the spring retaining members mounted on at least one of sides of each of the at least one compartment at the distal end is a magnetic spring retaining member configured to magnetically mount to the side of each of the at least one compartment at the distal end, wherein, the mounting the spring retaining members on each side of each of the at least one compartment at the distal end including magnetically mounting the at least one magnetic spring retaining member on at least one of the sides of each of the at least one compartment at the distal end;
inserting the plurality of containers of the liquid cleaning solvent into the manufactured vending machine;
pre-cooling the plurality of containers of the liquid cleaning solvent inserted into the manufactured vending machine prior to being automatically dispensed from the vending machine;
automatically dispensing the plurality of containers of the liquid cleaning solvent via the manufactured vending machine including:
moving the plurality of containers of the liquid cleaning solvent in the vertical orientation out of the front of each of the at least one compartment via the conveyor belt with the pushing block including holding the plurality of containers of the liquid cleaning solvent in the vertical orientation while moving on the conveyor belt out of the front of each of the at least one compartment;
ensuring the dispensing of a single container or multi-pack of the liquid cleaning solvent via the spring retaining members mounted on each side of each of the at least one compartment at the distal end;
tracking an inventory of the plurality of containers of the liquid cleaning solvent inserted into the vending machine and automatically dispensed from the vending machine, wherein the tracking the inventory of the plurality of containers of the liquid cleaning solvent inserted into the vending machine and automatically dispensed from the vending machine including:
attaching an RFID tag to each of the plurality of containers of the liquid cleaning solvent;
mounting an RFID antenna above each dispensing tray provided in the vending machine, the RFID antenna is configured to track the plurality of containers of the liquid cleaning solvent in the dispensing tray via the RFID tags attached to each of the plurality of containers of the liquid cleaning solvent; and
providing real-time inventory tracking of the plurality of containers of the liquid cleaning solvent inserted into the vending machine and automatically dispensed from the vending machine via the RFID antenna and the RFID tags, the provided real-time inventory tracking is configured to providing efficient restocking and preventing stockouts;
displaying the plurality of containers of the liquid cleaning solvent inserted into the vending machine through a transparent front window;
insulating the inside of the vending machine by providing an injected foam cabinet;
maintaining a required temperature inside of the vending machine via a temperature control feature, wherein the required temperature is configured to be set to maintain the liquid cleaning solvent at the required temperature of the liquid cleaning solvent;
detecting leaks inside and from the vending machine via a leak detection and containment system configured to prevent and address spills or leaks promptly;
displaying prices, programming messages, machine status, product labels, or combinations thereof via a display monitor;
providing a user-friendly touchscreen interface configured to display product information, prices, any necessary warnings or combinations thereof;
transporting each of the plurality of containers of the liquid cleaning solvent via an elevator, configured to transport each of the plurality of containers from a tray area to a collection box;
restricting the vertical movement of the elevator via a blocking mechanism configured to mitigate a risk of theft through a collection door of the collection box by securing the plurality of containers of the liquid cleaning solvent on the dispensing trays;
locking the vending machine via a secure locking system configured to prevent unauthorized access and ensure safety of the stored solvents;
conducting surveillance of the vending machine and the plurality of containers of the liquid cleaning solvent automatically dispensed therefrom via a surveillance system configured for security and monitoring purposes;
tracking the vending machine location via an asset tracking feature configured to locate the vending machine; and
accepting cashless payment options including credit card or mobile payments configured to provide convenience and ease of use of the vending machine.

12. A vending machine for automatic dispensing of a plurality of containers of a liquid cleaning solvent comprising:
at least one dispensing tray with at least one compartment;
each of the at least one compartment including a conveyor belt with a pushing block;
each of the at least one compartment is configured for holding the plurality of containers of the liquid cleaning solvent in a vertical orientation on the conveyor belt;
the pushing block is configured to move the plurality of containers of the liquid cleaning solvent on the conveyor belt out of a front of each of the at least one compartment;
each of the at least one compartment including a longitudinal spacer member on each longitudinal side of each of the at least one compartment, the longitudinal spacer members on each longitudinal side of each of the at least one compartment are configured to center and hold the plurality of containers of the liquid cleaning solvent in the vertical orientation on the conveyor belt as they are moved out of the front of each of the at least one compartment; and
wherein, the vending machine is designed and configured to provide automatic dispensing of the plurality of containers of the liquid cleaning solvent.

13. The vending machine of claim 12, wherein at least one of each of the at least one compartment including a bottle width between the longitudinal spacer members on each longitudinal side of each of the at least one compartment, where the bottle width is sized to hold the plurality of containers of the liquid cleaning solvent in the vertical orientation on the conveyor belt as the plurality of containers of the liquid cleaning solvent are moved out of the front of each of the at least one compartment via the conveyor belt with the pushing block.

14. The vending machine of claim 12, wherein the plurality of containers of the liquid cleaning solvent including a plurality of multi-packs of the plurality of containers of the liquid cleaning solvent, each multi-pack including at least two of the plurality of containers of the liquid cleaning solvent packaged side-by-side; and
wherein at least one of the at least one compartment including a package width between the longitudinal spacer members on each longitudinal side of each of the at least one compartment, where the package width is sized to hold the plurality of the multi-packs of the plurality of containers of the liquid cleaning solvent in the vertical orientation on the conveyor belt as the plurality of the multi-packs of the plurality of containers of the liquid cleaning solvent are moved out of the front of each of the at least one compartment via the conveyor belt with the pushing block.

15. The vending machine of claim 12 further comprising:
a refrigeration unit associated with the vending machine, the refrigeration unit is configured to refrigerate an inside of the vending machine; and
the refrigeration unit is configured to pre-cool the plurality of containers of the liquid cleaning solvent inserted into the vending machine prior to the vending machine automatically dispensing the plurality of containers of the liquid cleaning solvent.

16. The vending machine of claim 12, wherein the at least one dispensing tray with the at least one compartment with the conveyor belt with the pushing block including spring retaining members mounted on each side of each of the at least one compartment at a distal end; and
wherein, the spring retaining members on each side of each of the at least one compartment at the distal end is configured to ensure the dispensing of a single container of the liquid cleaning solvent.

17. The vending machine of claim 16, wherein at least one of the spring retaining members mounted on at least one of sides of each of the at least one compartment at the distal end is a magnetic spring retaining member configured to magnetically mount to the side of each of the at least one compartment at the distal end; and
wherein, each of the at least one of the magnetic spring retaining member including a magnet configured for magnetically mounting the magnetic spring retaining member to the side of each of the at least one compartment at the distal end.

18. The vending machine of claim 12 further comprising:
a plurality of RFID tags, each of the plurality of RFID tags is attached to one of the plurality of containers of the liquid cleaning solvent on a cap of each of the plurality of containers;
at least one RFID antenna, each of the at least one RFID antennas is mounted above one of the dispensing trays in the vending machine either below a top of the vending machine or on an underside of a dispensing tray;
each of the at least one RFID antennas is configured to track the plurality of containers of the liquid cleaning solvent in the dispensing tray via each of the plurality of the RFID tags attached to each of the plurality of containers of the liquid cleaning solvent;
wherein, the vending machine is configured to track an inventory of the plurality of containers of the liquid cleaning solvent inserted into the vending machine and automatically dispensed from the vending machine; and
wherein, the vending machine is configured to provide real-time inventory tracking of the plurality of containers of the liquid cleaning solvent inserted into the vending machine and automatically dispensed from the vending machine via the RFID antenna and the plurality of the RFID tags, the provided real-time inventory tracking is configured to providing efficient restocking and preventing stockouts.

19. The vending machine of claim 12 further comprising:
a transparent front window configured for displaying the plurality of containers of the liquid cleaning solvent inserted into the vending machine;
an injected foam cabinet configured to insulate the inside of the vending machine;
a temperature control feature configured to maintain a required temperature inside of the vending machine, wherein the required temperature is configured to be set to maintain the liquid cleaning solvent at the required temperature of the liquid cleaning solvent;
a leak detection and containment system configured to detect leaks inside and from the vending machine, the leak detection and containment system is configured to prevent and address spills or leaks promptly;
a display monitor configured to display prices, programming messages, machine status, product labels, or combinations thereof;
a user-friendly touchscreen interface configured to display product information, prices, any necessary warnings or combinations thereof;
an elevator configured to transport dispensed containers of the liquid cleaning solvent, the elevator is configured to transport each dispensed container from a tray area to a collection box;
a blocking mechanism configured to restrict vertical movement of the elevator, the blocking mechanism is configured to mitigate a risk of theft through a collection door of the collection box by securing the plurality of containers of the liquid cleaning solvent on the dispensing trays;
a secure locking system configured to lock the vending machine, the secure locking system is configured to prevent unauthorized access and ensure safety of the stored containers of the liquid cleaning solvent;
a surveillance system configured to conduct surveillance of the vending machine and the plurality of containers of the liquid cleaning solvent automatically dispensed therefrom, the surveillance system is configured for security and monitoring purposes;
an asset tracking feature configured to track the vending machine location, the asset tracking feature is configured to locate the vending machine;
a cashless payment feature configured to accept cashless payment options including credit card or mobile payments, the cashless payment feature is configured to provide convenience and ease of use of the vending machine; or combinations thereof.

20. The vending machine of claim 12 further comprising:
a transparent front window configured for displaying the plurality of containers of the liquid cleaning solvent inserted into the vending machine;
an injected foam cabinet configured to insulate the inside of the vending machine;
a temperature control feature configured to maintain a required temperature inside of the vending machine, wherein the required temperature is configured to be set to maintain the liquid cleaning solvent at the required temperature of the liquid cleaning solvent;
a leak detection and containment system configured to detect leaks inside and from the vending machine, the leak detection and containment system is configured to prevent and address spills or leaks promptly;
a display monitor configured to display prices, programming messages, machine status, product labels, or combinations thereof;
a user-friendly touchscreen interface configured to display product information, prices, any necessary warnings or combinations thereof;
an elevator configured to transport dispensed containers of the liquid cleaning solvent, the elevator is configured to transport each dispensed container from a tray area to a collection box;
a blocking mechanism configured to restrict the vertical movement of the elevator, the blocking mechanism is configured to mitigate a risk of theft through a collection door of the collection box by securing the plurality of containers of the liquid cleaning solvent on the dispensing trays;
a secure locking system configured to lock the vending machine, the secure locking system is configured to prevent unauthorized access and ensure safety of the stored containers of the liquid cleaning solvent;
a surveillance system configured to conduct surveillance of the vending machine and the plurality of containers of the liquid cleaning solvent automatically dispensed therefrom, the surveillance system is configured for security and monitoring purposes;
an asset tracking feature configured to track the vending machine location, the asset tracking feature is configured to locate the vending machine; and
a cashless payment feature configured to accept cashless payment options including credit card or mobile payments, the cashless payment feature is configured to provide convenience and ease of use of the vending machine.
